(19) United States
(12) Patent Application Publication
(10) Pub. No.: US 2007/0050423 A1
(43) Pub. Date: Mar. 1, 2007

(54) Intelligent general duplicate management system

(75) Inventors: Thor Caleb Whalen, Atlanta, GA (US); Hemant M. Kurande, Alpharetta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Scentric, Inc., Alpharetta, GA (US)

(21) Appl. No.: 11/512,973

(22) Filed: Aug. 30, 2006

Related U.S. Application Data
(60) Provisional application No. 60/712,319, filed on Aug. 30, 2005.
(60) Provisional application No. 60/712,672, filed on Aug. 30, 2005.

(51) Int. Cl. G06F 17/30

(52) U.S. Cl. 707/200

(57) ABSTRACT

A method of managing duplicate electronic files for a plurality of users across a distributed network, the electronic files being from a plurality of different file types, comprising selecting a file type from the plurality of different file types, selecting properties of the electronic files for the selected file type that must be identical in order for two respective electronic files of the selected file type to be considered duplicates, selected properties defining pertinent data of the electronic files for selected file type, grouping electronic files of selected file type stored in the network, ranking said groupings from highest to lowest based on a likelihood of having duplicate electronic files therein, systematically comparing pertinent data of electronic files from said highest to said lowest ranked groupings, identifying duplicates from said ranked groupings based on said systematic comparisons, and purging or generating a report regarding said identified duplicates on the network.

### CROSS REFERENCE TO RELATED APPLICATION

This application claims the benefit under 35 U.S.C. § 119(e) of U.S. Provisional Patent Application No. 60/712,319, entitled “System and Method to Create a Duplication Density Map from a Model of File Operation Dynamics,” filed Aug. 30, 2005, and 60/712,672, entitled “Methods for Detecting Duplicates in Large File Systems,” each of which is incorporated herein by reference in its entirety.

### FIELD OF THE PRESENT INVENTION

The present invention relates generally to electronic file management systems, and, more particularly, to methods and systems for managing duplicate electronic files in large or distributed file systems.

### BACKGROUND OF THE PRESENT INVENTION

Duplicate documents or electronic files (or “duplicates,” for short) are typically created in computer networks or systems by file operations such as file creation, copy, transmission (via email attachment), and download (from an external site). Other operations, such as file deletion and edit, can affect the density of duplicates in a particular region of a distributed file server negatively.

The problem of detecting and managing duplicates in large or distributed file systems is one of growing interest, since effective management has the potential to save a considerable amount of storage memory while, at the same time, optimizing the accessibility and reliability afforded by organized duplication.

### The Need for Duplicate Detection and Management

Not surprisingly, a considerable amount of disk space is wasted on duplicate documents and electronic files. For example, during the U.S. government's Gulf War Declassification Project in December 1996, it was estimated that approximately 292,000 out of the 564,000 pages gathered were duplicates. Further, one recent study of electronic traffic passing through the main gateway of the University of Colorado computer network found that duplicate transmissions accounted for over 54% of the file transmission traffic through the gateway. Further, an article in the Journal of Computer Sciences in 2000 claimed, at that time, that over 20% of publicly-available documents on the Internet were duplicates or near duplicates.

On the other hand, file duplication presents many advantages that can be and are often exploited in some systems. Such advantages include reliability, availability, security, and the like. However, in order for the storage overhead caused by file duplication to be useful, the duplicates must be voluntary and/or they must be managed. Locating and supervising duplicates is a problem of growing interest in storage management, but also in information retrieval, publishing, and database management.

Effectively managing duplicates offers offer many potential advantages—such as reducing storage and bandwidth requirements, enabling version control and detection of plagiarism, and accelerating web-crawling, indexing, database searching, and file retrieval. Currently, many different techniques for attempting to manage duplicates have been proposed—differing in the type of data that is handled, what it means for two data items to be “duplicates,” how duplicates are handled, and the implementation environment in which the duplicates are being managed, and the constraints of the implementation environment.

### Disparate Meanings of “Duplicate”

An examination of current literature, patents, and commercially-available software applications in the field of file duplication reveals that there are many conflicting ideas of what it means for two files to be duplicates. Following are a few examples of different notions of duplication.

Content and meta-data duplicates: In the software application called “Duplicate File Finder v.2.1” currently published by a company called DGeko (see, e.g., http://duplicate-file-finder.dgeko.com), two files are considered to be duplicates if they have the same name, size and time stamp. In contrast, in a different software application called “UnDup” currently published by an individual named Charlie Payne (see, e.g., http://www.armory.com/˜charlie/undup), two files are considered duplicates only if they have the same contents—the file name being completely ignored. A number of currently-available file duplicate detection software applications enable the user to specify what properties (e.g. name, size, date, content, CRC, MD5) must identically agree for two files to be considered duplicates.

Alternate representation duplicates: Defining duplication on the basis of matching data or meta-data, however, is not the only option. Two files can be said to be semantically identical if they are identical when viewed or used by a secondary process. It may be that two documents, though semantically identical, are nevertheless represented differently on the byte level. For example, documents may be encrypted differently from user to user for security reasons. It may also be that two semantically identical files differ in their internal representation because different compression methods may have been used to store them or they were saved under two different versions of the same application—for example, if one uses a program, such as Word2003 published by Microsoft, to open a document that was originally created in Word2002, inserts and then deletes a space, then saves it again, the size (therefore the contents) of the file will change even though the actual document would not visually appear to be any different.

Image document duplicates: Another scenario in which “duplicates” may have considerably different byte-level representations occurs when considering duplicate images of scanned, faxed, or copied documents. In this situation, duplication may be defined on the basis of the contents of document as perceived by the viewer, and special techniques must be applied to automatically factor out the representational discrepancies inherent to image documents. Much research has been done and is currently being done in the area.

Similar documents: In some cases, it may also be useful to regard two highly similar files as duplicates. For example, this may occur when several edited versions of a given original file are saved. Indeed, a file duplicate management application may save storage space by representing several similar files using one large central file, and several small “difference files” used to recover the original files from the central one.

Inner-file duplicates: Some systems consider duplication at a deeper level than the file itself. For example, U.S. Pat. No. 6,757,893 describes a method to find identical lines software code throughout a group of files, and a version control system that stores source code on a line-to-line basis. Further, U.S. Pat. No. 6,704,730 describes a storage system that discovers identical byte sequences in a group of files, storing these only once.

### Disparate Ways of “Purging” Duplicates

In storage management, the goal of locating duplicates is often to purge the file system of needless redundancy. The present system described herein uses the phrase “purging duplicates” to mean more than merely, straightforward “deletion” of a duplicate file. Indeed, though simply deleting duplicates may be appropriate in some situations, it can be problematic to do in many situations because this would negate the user's ability to retrieve a file from the location in which he had placed it.

The term “purging duplicates”, as used hereinafter, designates the action of changing the way “duplicates” are stored and/or processed. For example, in many cases, this involves expunging the bulk of (redundant) data of a duplicate file, keeping only one copy, but taking the necessary steps so that the file may still be readily accessed; just as if the user owned his own copy. The following are a few examples:

Content duplicates: If two files having equal contents are considered to be “duplicates,” identical contents of several files may be stored once (taking care to link all instances of the duplicate files to this common content), the original meta-data of these files being conserved. For example, U.S. Pat. No. 6,477,544 describes a “method and system for storing the data of files having duplicate content, by maintaining a single instance of the data, and providing logically separate links to the single instance.”

Alternate representation duplicates: A common representation can be stored, taking care to attach a “key” to every duplicate instance that would allow each file to recover its original representation.

Image document duplicates: It is sometimes preferable to keep only one copy of an image document (probably the one with the highest quality) and link all other instances to it. Alternatively, it may be desirable to keep all duplicate instances, but to “group” them to maintain orderliness.

Similar documents: A system may maintain a list of “edit (or difference) files” along with an “original file” so that the system may reconstruct any version of the document, if that is ever necessary.

What it means to “purge” duplicates is closely tied to how one defines duplicates in the first place. Such definition is also closely tied to the implementation environment in which duplicate management is implemented.

### Disparate Modes of Duplicate Detection and Purging

There is also significant diversity in the way systems carry out the processes of duplicate detection and purging. An important aspect of duplication management and purging hinges upon when actions are taken. Is detection and purging occurring “after-the-fact” or “on-the-fly” (with respect to when the file was created) or some time therebetween?

For example, Google's current duplicate detection and purging system is implemented after-the-fact since the system has no control over the creation of the files it processes.

In U.S. Pat. No. 6,615,209, which is assigned to Google, guides duplicate detection using query-relevant information.

A number of commercially-available software applications typically detect and purge duplicates after-the-fact as well, in order to organize or clean up the file system.

U.S. Pat. Nos. 6,389,433 and 6,477,544 describe duplicate detection and purging processes that are scheduled dynamically according to disk activity, and (after an initial full disk scan) using the USN log (which records changes to a file system) to guide duplicate detection.

On the other end of the spectrum, it is possible to maintain a “duplicate free” system by performing duplicate detection “on-the-fly” by detecting and purging the duplicates as they appear.

For these and many other reasons, there is a general need for systems and methods of managing duplicate electronic files for a plurality of users across a distributed network, the electronic files being from a plurality of different file types, comprising the steps of (i) selecting a file type from the plurality of different file types; (ii) selecting properties of the electronic files for the selected file type that must be identical in order for two respective electronic files of the selected file type to be considered duplicates, the selected properties defining pertinent data of the electronic files for the selected file type; (iii) grouping electronic files of the selected file type stored in the distributed network; (iv) ranking said groupings from highest to lowest based on a likelihood of having duplicate electronic files therein; (v) systematically comparing pertinent data of electronic files from said highest to said lowest ranked groupings; and (vi) identifying duplicates from said ranked groupings based on said systematic comparisons.

There is also a need for system and methods of managing duplicate electronic files for a plurality of users across a distributed network, the electronic files being of a particular file type, comprising the steps of (i) selecting properties of the electronic files that must be identical in order for two respective electronic files to be considered duplicates, the selected properties defining pertinent data of the electronic files; (ii) grouping electronic files stored in the distributed network based on file operation information or based on users associated with the electronic files; (iii) ranking said groupings from highest to lowest based on a likelihood of having duplicate electronic files therein; (iv) systematically comparing pertinent data of electronic files from said highest to said lowest ranked groupings; (v) identifying duplicates from said ranked groupings based on said systematic comparisons; and (vi) purging identified duplicates from the network.

There is a further need for systems and methods that perform duplicate detection and purging that focus first on database regions or file locations having or likely to have a high density or number of duplicates. Doing so allows one to find many duplicates early on, maximizing the number of duplicates that can be found in a limited amount of time, and minimizing the time needed to find all duplicates (since only one file of a duplicate set need to be compared to others for duplication verification).

There is yet a further need for a system and methods that use the dynamics of file operations to create a duplication density map of the file system, which in turn may be used to guide the search for duplicates, making duplicate detection more efficient.

The present invention meets one or more of the above-referenced needs as described herein in greater detail.

### SUMMARY OF THE PRESENT INVENTION

The present invention relates generally to electronic file management systems, and, more particularly, to methods and systems for managing duplicate electronic files in large or distributed file systems. Briefly described, aspects of the present invention include the following.

In a first aspect, the present invention is directed to systems and methods to automatically guide duplicate detection according to file operations dynamics. Depending on the situation at hand, one may want to detect particular kinds of duplicates and, in some case, wish to purge these duplicates in a specific manner and frequency. The present systems and methods provide intelligent or adaptive handling of many different kinds of duplicates and uses a plurality of methods for such handling. The present system is more than just a hybrid duplicate management scheme—it offers a unified approach to several aspects of duplicate management. Moreover, the present system enables one to scale the implementation of the detection and purging processes, within the range between “after-the-fact” and “on-the-fly,” using specific aspects of file operation dynamics to guide these processes.

A second aspect of the present invention is directed to a method of managing duplicate electronic files for a plurality of users across a distributed network, the electronic files being from a plurality of different file types, comprising the steps of (i) selecting a file type from the plurality of different file types; (ii) selecting properties of the electronic files for the selected file type that must be identical in order for two respective electronic files of the selected file type to be considered duplicates, the selected properties defining pertinent data of the electronic files for the selected file type; (iii) grouping electronic files of the selected file type stored in the distributed network; (iv) ranking said groupings from highest to lowest based on a likelihood of having duplicate electronic files therein; (v) systematically comparing pertinent data of electronic files from said highest to said lowest ranked groupings; and (vi) identifying duplicates from said ranked groupings based on said systematic comparisons.

In a feature, the file type is indicative of the application used to create, edit, view, or execute the electronic files of said file type.

In another feature of this aspect, the selected properties are common to more than one of the plurality of different file types.

Preferably, properties of the electronic files include file metadata and file contents, wherein file metadata and file contents include one or more of file name, file size, file location, file type, file date, file application version, file encryption, file encoding, and file compression.

In a feature, grouping electronic files is based on file operation information and/or based on users associated with the electronic files.

In another feature, ranking said groupings is made using duplication density mapping that identifies a probability of duplicates being found within each respective grouping, wherein (i) the probability is based on information about the users associated with the electronic files of each respective grouping, (ii) the probability is modified based on previous detection of duplicates within said groupings, and/or (iii) the probability is modified based on file operation information. File operation information is provided by a file server on the distributed network, is obtained from monitoring user file operations, is obtained from a file operating log, and/or includes information regarding email downloads, Internet downloads, and file operations from software applications associated with the electronic files.

In another feature, systematically comparing is conducted by recursive hash sieving the pertinent data of the electronic files, wherein, preferably, recursive hash sieving progressively analyzes selected portions of the pertinent data of the electronic files.

In yet further features, systematically comparing is conducted by comparing electronic files on a byte by byte basis, further comprises the step of computing the pertinent data of the electronic files, further comprises the step of retrieving the pertinent data of the electronic files, further comprises comparing sequential blocks of pertinent data from the electronic files, further comprises comparing nonsequential blocks of pertinent data from the electronic files, is performed on a batch basis, and/or is performed in real time in response to a selective file operation performed on a respective electronic file, or any combinations of the above.

In another feature, the method further comprises one or more of the steps of generating a report regarding said identified duplicates, deleting said identified duplicates from the network, purging duplicative data from said identified duplicates on the network, identifying one common file for each of said identified duplicates and identifying a respective specific file for each electronic file of said identified duplicates wherein the common file includes the pertinent data of said identified duplicates.

In yet another feature, the method of the second aspect of the invention further comprises the step of modifying at least one electronic file to obtain its pertinent data wherein said step of modifying comprises converting said electronic file into a different file format and/or wherein said step of modifying comprises converting said electronic file into a different application version.

A third aspect of the present invention is directed to a method of managing duplicate electronic files for a plurality of users across a distributed network, the electronic files being of a particular file type, comprising the steps of (i) selecting properties of the electronic files that must be identical in order for two respective electronic files to be considered duplicates, the selected properties defining pertinent data of the electronic files; (ii) grouping electronic files stored in the distributed network based on file operation information or based on users associated with the electronic files; (iii) ranking said groupings from highest to lowest based on a likelihood of having duplicate electronic files therein; (iv) systematically comparing pertinent data of electronic files from said highest to said lowest ranked groupings; (v) identifying duplicates from said ranked groupings based on said systematic comparisons; and (vi) purging identified duplicates from the network.

Preferably, properties of the electronic files include file metadata and file contents, wherein file metadata and file contents include one or more of file name, file size, file location, file type, file date, file application version, file encryption, file encoding, and file compression.

In a feature, grouping electronic files is based on file operation information and/or based on users associated with the electronic files.

In another feature, ranking said groupings is made using duplication density mapping that identifies a probability of duplicates being found within each respective grouping, wherein (i) the probability is based on information about the users associated with the electronic files of each respective grouping, (ii) the probability is modified based on previous detection of duplicates within said groupings, and/or (iii) the probability is modified based on file operation information. File operation information is provided by a file server on the distributed network, is obtained from monitoring user file operations, is obtained from a file operating log, and/or includes information regarding email downloads, Internet downloads, and file operations from software applications associated with the electronic files.

In another feature, systematically comparing is conducted by recursive hash sieving the pertinent data of the electronic files, wherein, preferably, recursive hash sieving progressively analyzes selected portions of the pertinent data of the electronic files.

In yet further features, systematically comparing is conducted by comparing electronic files on a byte by byte basis, further comprises the step of computing the pertinent data of the electronic files, further comprises the step of retrieving the pertinent data of the electronic files, further comprises comparing sequential blocks of pertinent data from the electronic files, further comprises comparing nonsequential blocks of pertinent data from the electronic files, is performed on a batch basis, and/or is performed in real time in response to a selective file operation performed on a respective electronic file, or any combinations of the above.

In another feature, the method further comprises one or more of the steps of generating a report regarding said identified duplicates, deleting said identified duplicates from the network, purging duplicative data from said identified duplicates on the network, identifying one common file for each of said identified duplicates and identifying a respective specific file for each electronic file of said identified duplicates wherein the common file includes the pertinent data of said identified duplicates.

In yet another feature, the method of the third aspect of the invention further comprises the step of modifying at least one electronic file to obtain its pertinent data wherein said step of modifying comprises converting said electronic file into a different file format and/or wherein said step of modifying comprises converting said electronic file into a different application version.

The present invention also encompasses computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 illustrates components of one embodiment of the present invention, whereby the files of a distributed file server are managed by a central “duplicate management” system;

FIG. 2 illustrates a general flow chart in which a file management system in an embodiment of the present invention purges the stored data according to rules (duplication definitions and purging action specifications) set by an administrator, and using file operations information to guide the process;

FIG. 3 illustrates a general definition of file duplication, whereby files are duplicates if they differ only by some specific (and small amount of) information;

FIG. 4 illustrates a slightly less general definition of file duplication;

FIG. 5 is a flow chart showing a broad view of a duplicate detection and purging process of the present invention;

FIG. 6 is a flow chart showing a slightly more detailed view of an example of a duplicate detection process using an inputted definition of duplication.

FIG. 7 depicts an exemplary scheme for performing a byte-to-byte comparison of two blocks of data in a way that reduces the average amount of comparisons needed before finding discrepancies;

FIG. 8 depicts the general scheme of “hash sieving” whereby a group of blocks of data is recursively divided in subgroups of blocks that hash to identical values;

FIG. 9 represents an exemplary data-structure that is used by one pass of a “hash sieving” process;

FIG. 10 represents an exemplary data-structure that is used by a multiple passes of a “hash sieving” process;

FIG. 11 represents an alternate data-structure that is used by a multiple passes of a “hash sieving” process;

FIG. 12 illustrates a small duplicate density map;

FIG. 13 illustrates another exemplary duplicate density map;

FIG. 14 is a flow chart exhibiting a general approach to the problem of using knowledge of file operations to construct better duplicate density maps;

FIG. 15 is a flow chart exhibiting a specific approach to the problem of using knowledge of file operations to construct better duplicate density maps in an embodiment of the present invention;

FIG. 16 illustrates the directory structure of a small exemplary file system;

FIG. 17 is a simple density map cell for the file system depicted in FIG. 16;

FIG. 18 is a domain, with four cells, for a density map for the file system depicted in FIG. 16;

FIG. 19 is a “Cartesian” depiction (as in FIG. 12 and FIG. 13) of the domain shown in FIG. 18;

FIG. 20 is another four cell domain for a density map for the file system depicted in FIG. 16;

FIG. 21 is a “Cartesian” depiction (as in FIG. 12 and FIG. 13) of the domain shown in FIG. 20;

FIG. 22 is a flow chart exhibiting a specific approach to the problem of using knowledge of file operations to construct better duplicate density maps in another embodiment of the present invention;

FIG. 23 shows examples of (highly probable) duplicate groups as used in the embodiment of FIG. 22;

FIG. 24 indicates what actions should be taken when given specific file operations as used in the embodiment of FIG. 22;

FIG. 25 illustrates a scheme for maintaining a purged representation of files during a copy operation;

FIG. 26 illustrates a scheme for maintaining a purged representation of files during a delete operation.

### DETAILED DESCRIPTION OF PREFERRED EMBODIMENTS

### General Overview

The present invention is directed to systems and methods to automatically guide duplicate detection according to file operations dynamics. Depending on the situation at hand, one may want to detect particular kinds of duplicates and, in some case, wish to purge these duplicates in a specific manner and frequency. The present system provides intelligent or adaptive handling of many different kinds of duplicates and uses a plurality of methods for such handling. The present system is more than just a hybrid duplicate management scheme—it offers a unified approach to several aspects of duplicate management. Moreover, the present system enables one to scale the implementation of the detection and purging processes, within the range between “after-the-fact” and “on-the-fly,” using specific aspects of file operation dynamics to guide these processes.

### Generic Definition of Duplication and Purging

Initially, it is advantageous to provide a rigorous and general definition of duplication, formalizing the idea that most notions of duplication can be translated as equality of some aspect of the information the duplicates carry. The definition of duplication as used herein subsumes most of the definitions mentioned in the background of the invention. This allows the present system to be designed in a flexible manner, which is readily scalable to numerous, sensible characterizations of duplicates and management thereof. Defining duplicates and receiving input into the system of a customized definition affects only the initial steps of the duplicate detection process, thus, no reconfiguration of subsequent processes is necessary to accommodate new definitions. Using a broad definition of duplication also enables a broad range of manners in which purging can be performed.

### Flexible and Intelligent Comparison of Collections of Files

In one aspect of the invention, deciding if two files are duplicates boils down to deciding if two blocks of data (hereinafter “pertinent data”) are identical on a byte by byte comparison (i.e., “byte-wise identical”). Preferably, detecting duplicates in a set of files is performed by grouping these files according to their “pertinent data” identity. Methods to do this efficiently are described in greater detail hereinafter.

In order to group identical blocks of data, the system uses “cyclic (or recursive) hash sieving.” In this scheme, a collection of blocks is gradually divided into groups according to their hash value. Since two blocks that hash with different hash values are certainly non-identical, the next “hash sieving cycle” only needs to be performed on the individual groups that have more than one block. The choice of the hash function used during each cycle of this hash sieving process can be done automatically and adaptively using standard machine learning techniques.

### Guiding Duplicate Detection Using File Operation Dynamics

The system uses file operation dynamics information to perform duplicate management on-the-fly and/or guide after-the-fact duplicate detection.

To guide duplicate detection and to reduce the amount of time required to find duplicates, the present system preferably uses a “duplicate density map.” A duplicate density map can have many different embodiments and forms—from the attribution of a probability of duplication for given sets of pairs of files to a list of groups of highly probable duplicates and anything in between. These duplicate density maps use information on certain file operations that effect duplication. This information may be more or less complete and may be obtained through a monitoring process or simply by reading logs already existing in the file server. Missing information is approximated using statistical methods.

As stated previously, there are many possible causes of duplication, such as file copying, downloading of identical files from the web, and downloading of attachments sent between users of a same file system.

It is possible for a process to maintain a duplicate-free space by disallowing any duplicates to be created in the first place. Alternatively, it is possible for a process to keep track of all duplicates, along with their location, so that it may clean the file system efficiently when instructed to. This can be done, for example, by monitoring each and every system call.

Yet detecting and managing duplication on-the-fly requires a significant amount of intrusiveness to the operating system, memory, and processing time; thus, such an approach is often undesirable. It is often more advantageous to perform duplicate detection only “after-the fact,” when computing resources are more available.

During “after-the-fact” duplicate detection, it is beneficial to find as many duplicates early on. Indeed, if the time allocated for duplicate detection is restricted, this approach allows the file system to be as “clean” as possible when the process is terminated. Furthermore, in the frequent case where duplication defines an equivalence relation, only one file of a set of files already determined to be duplicates needs to be compared to the other files of the file system. Thus, finding duplicates early on reduces the total number of comparisons that need to be made.

For this reason, it is advantageous to know, at the time when duplicate detection is performed, which parts of the file system are more likely to contain duplicates. As discussed herein, the present system enables the creation and dynamic updating of a “probability of duplication” (or, equivalently “duplicate density”) map of the file system, using observed and inferred information of file operation dynamics.

### An Exemplary Framework: Multi-User File Server

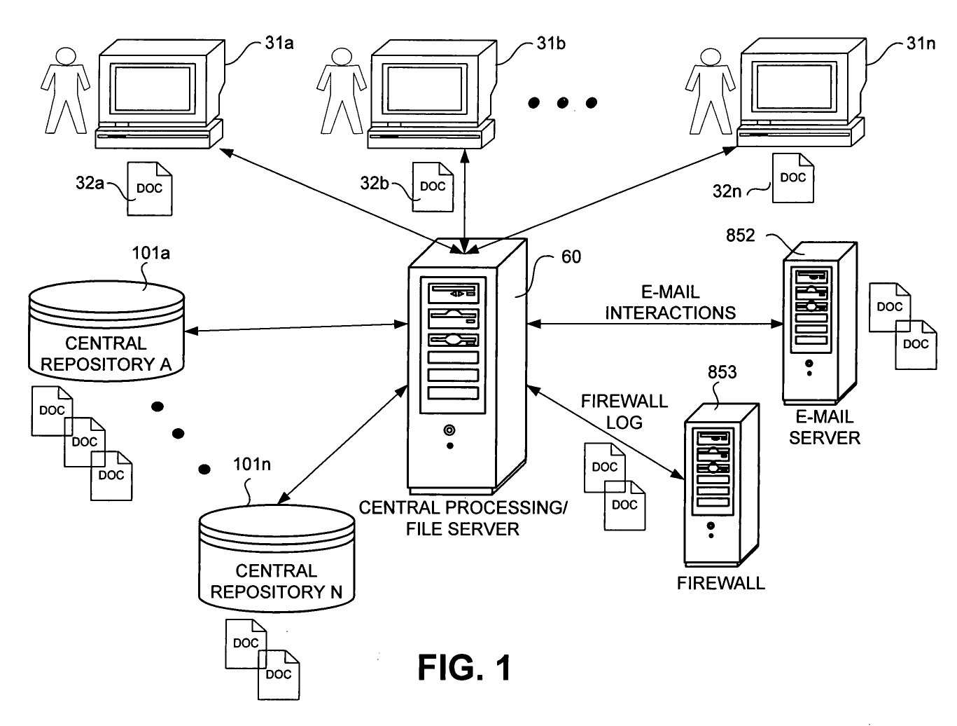

FIG. 1 illustrates a high level, exemplary implementation framework for the present system. A plurality of users 31a, 31b . . . 31n operate (e.g., create, edit, delete, copy, move, etc.) on files 32a, 32b . . . 32n managed by central processor/file server 60 in a distributed network environment. Files are stored on one or more central file repositories 101a . . . 101n. These central file repositories 101 are independent of one another and do not have to have common hardware. In addition to creating new documents and manipulating them, each of the users is able to download documents from the Internet through a firewall 853. Documents are also shared between users via e-mail communication, managed by an email server 852. Email attached documents may be resaved by the recipient and, again, stored on one of the central repositories 101a . . . 101n. Web downloads are managed by a network firewall 853. It will also be appreciated that users 31 may visit the same websites and download identical documents. Since copies of documents exchanged by e-mail communications and Internet downloads are stored in a distributed environment or on multiple repositories or databases, it is not easy to detect duplicates.

A duplicate management system residing on central processor/file server 60 is designed to capture and analyze the file operations performed by users 31a, 31b . . . 31n, as well as e-mail exchanges and Internet downloads by such users. By doing so, the duplicate management system is able to identify the approximate or exact location of duplicate documents based upon file operations performed by each user. The system establishes a map of data repositories that facilitates the efficient processing of duplicates, as will be described hereinafter.

### General Process

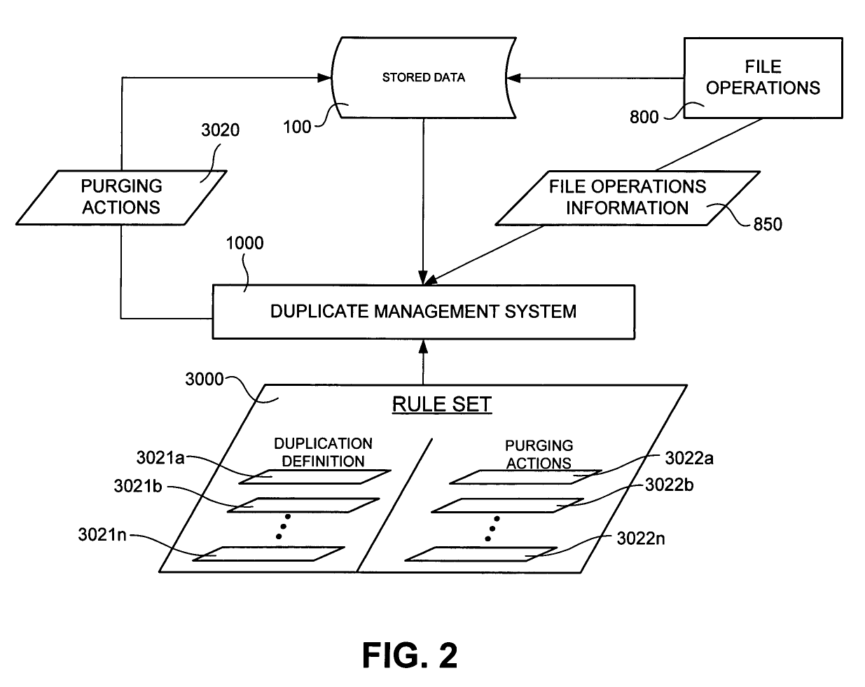

FIG. 2 illustrates the general components of the present invention as well as the process flow between such components. Data is originally created and transformed by file operations 800. These file operations 800 may be generated by processes and/or the users of the file system/server. Data is stored 100 in central repositories or databases, which may include an array of storage devices having different physical locations. The duplicate management system 1000 manages how such data is stored and maintained in such repositories, preferably by purging the stored data of duplicates by altering the representation of the stored data. Note that in the case of “on-the-fly” management of duplicates, it would be more natural to place the duplicate management system 1000 between the file operations 800 and the data storage 100. This scenario can also be represented in FIG. 2 by nullifying the direct influence of the file operations 800 on the stored data 100, having the duplicate management system 1000 manage all stored data (acting as “middleware”).

The duplicate management system 1000 uses rules set 3000 to determine what it must consider to be a “duplicate” and what it must do with the duplicates it finds. Rules set 3000 includes a plurality of duplicate definitions (definition of what it means to be a duplicate) 3021a, 3021b . . . 3021n and corresponding “purging actions” (specifies what to do with such duplicates when found) 3022a, 3022b . . . 3022n. It should be understood that a “duplicate definition” can specify what regions of the file system it must be applied to, what type of files it must apply to (e.g. media, text, etc.), or other relevant information. Also, the “purging actions” can specify when and/or how to handle the purging (e.g. on-the-fly, every day, once a month, etc.).

The duplicate management system 1000 uses file operations information 850 to guide its process of duplicate detection and purging. Eventually, the duplicate management system 1000 will take some purging actions 3020 on the stored data 100, as directed by the rules set 3000. One has to take care, when implementing this system, to treat the actions taken by the duplicate management system 1000 (which are, in effect, “file operations”) differently than normal file operations of 800.

### Mathematical Definition of a Duplicate

Since “duplication” is an important concept for the present system, a more precise definition of such term is warranted. Any sensible mathematical definition of duplication should describe a reflexive and symmetric relation on the pairs of files of a file system. That is, if [symbol] is the set of all files of the file system, and xDy denotes the statement “file x and file y are duplicates”, then for every xε [symbol] we should have
xDx,
   and for all x,yε [symbol] ,
if xDy then yDx.
   The reason for reflexivity is that a file is naturally a duplicate of itself. Further, symmetry is a natural property for duplication since if x is a duplicate of y then y is perforce a duplicate of x.

We will also add the transitive property to our definition of duplication. The relation D is said to be reflexive when, for all x,y,zε [symbol] ,
if xDy and yDz then xDz.
   The transitive property is justified when we think of a set of duplicate files as a cluster of files, all duplicates of each other, and disjoint from other clusters of duplicates. This is the case of many characterizations of duplication, but some do not fall into this category. For example, if we understand duplication as “highly similar,” it may be that a chain of files are successively duplicates of each other—yet the first and the last are not since they are not similar enough.

Relations which are reflexive, symmetric and transitive are called equivalence relations. We will restrict ourselves to this class of relations when defining duplication, and call this transitive duplication. It is not sufficient for a relation on a set of files to be an equivalence relation in order for it to convey our conventional intuition of duplication. Indeed, any partition of the set of files defines an equivalence relation; thus, we need to define the relation so as to impart our understanding of what it means for two files to be duplicates.

In order to do so, we refer back to the earlier concept of duplicate purging where a set of files is considered to be duplicates if they could be recovered from a common file C and a set of files specific to the original files. This leads to the following definition:

Definition 1 Let S and C be sets of files and f: S×C→ [symbol] be a surjective function onto the set [symbol] of files of the file system. Two files F₁, F₂ε [symbol] are said to be ƒ-duplicates if there exists S₁, S₂εS and CεC such that ƒ(S₁,C)=F₁ and ƒ(S₂,C)=F₂.

The files of S are called specific files and those of C, common files.

Observe that duplication is here defined by the function ƒ, including its domain. This illustrates that the conception of duplication depends on how the files of the file system are represented with the prescribed specific and common file sets. It may be that, according to the type of files or the file system in question, different functions ƒ are chosen to define duplication. When the choice of ƒ is understood, it may be omitted as a prefix of “duplicate.”

Two files are (ƒ-)duplicates if they can be represented using the same common file. It is easy to verify that ƒ-duplication is a reflexive and symmetric relation. Again, one may choose ƒ so that ƒ-duplication conveys nothing of one's natural intuition of duplication.

On the other hand, if the following restrictions are imposed:
1. S to files that are small compared to those of C, and
2. ƒ to functions that are “simple” and efficiently implementable,
   then ƒ-duplication will resemble the present conception of duplication. Condition 1 ensures that, since S₁ and S₂—the files that encode the difference of F₁ and F₂—are small compared to C means, F₁ and F₂ will enjoy a high degree of similarity. Condition 2 ensures that this similarity is not obscure and that the alternate (purged) representation of the files is impermeable to the user (since the system can quickly recover the original data from the common file and the specific file). It should also be noted that Condition 1 shows that the purged representation of the file system indeed saves space. These extra conditions are not included in the definition because the way one defines “small”, “simple” and “efficiently implementable”, depends on the goals a particular duplication purging scheme attempts to achieve and the way this scheme is implemented.

Observe that, in the spirit of the UNIX operating system, where everything is considered to be a file, the word file is loosely defined to be any sequence of bytes. For example, a “file” of a given file system is considered here to be the sequence of bytes representing its information entirely. This includes contents, but also metadata.

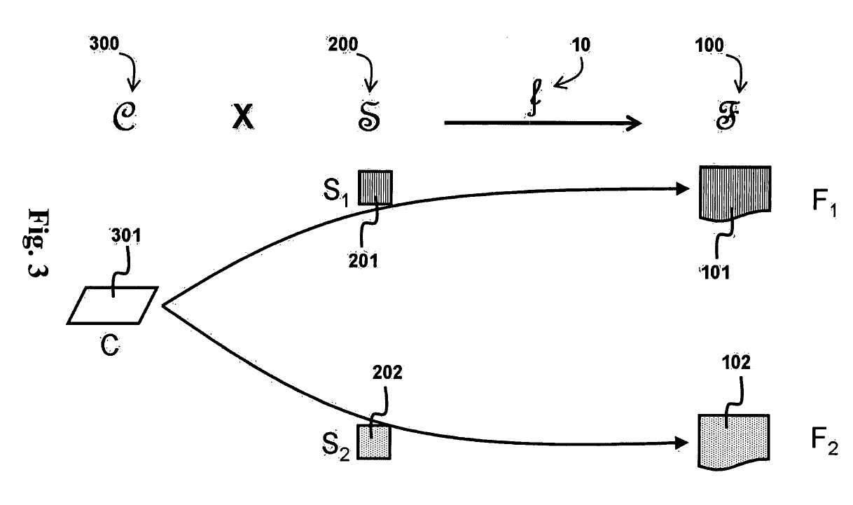

FIG. 3 illustrates Definition 1. [symbol] 100 represents the set of all possible files. S 200 is the set of specific files, and C 300 is the set of common files that are used to represent the files of [symbol] 100. The function ƒ 10 is the function defining how to combine a common (C) and specific (S) file to (re)create a given file that has been represented with these common and specific files. In this sense, this function is a “recovering” function since it shows how one can reconstruct an original file that has been represented by a pair of files (one from C 300 and one from S 200). For example, common file C 301 is combined (through ƒ) with a specific file S₁ 201 to produce file F₁ 101. On the other hand, the same common file C 301, when combined with specific file S₂ 202, produces the file F₂ 102. Though files F₁ 101 and F₂ 102 are not byte-wise identical, they are considered to be duplicates from the point of view of the “recovering” function ƒ 10.

Definition 1 describes all of the duplication concepts mentioned earlier. For example, the specific files may encode the “difference files” of “Single Instance Storage in Windows 2000” by William Bolosky and U.S. Pat. No. 6,477,544, or the “edit operations” of “String Techniques for Detecting Duplicates in Document Databases” or “A Comparison of Text-Based Methods for Detecting Duplicates in Scanned Document Databases,” both authored by Daniel Lopresti. The function ƒ 10 then recovers the original files by transforming (or “enhancing”) the common file C according to the specific files S₁ or S₂. In the case of document images, the common files C play the role of textual content and the specific files S of noise/distortions.

It should be noted that when duplication is viewed, as described in Definition 1, it is not necessarily an equivalence relation since it is not necessarily transitive. On the other hand, if one only considers functions ƒ that are injective, then the relation must be transitive. Indeed, in this case, every file Fε [symbol] has a unique inverse function ƒ⁻¹(F) in S×C, so verifying if two files F₁ and F₂ are duplicates consists of verifying if ƒ⁻¹(F₁)=ƒ⁻¹(F₂), which is obviously transitive.

This shows that by choosing an appropriate bijective function g: [symbol] →S×C, one may define (a transitive) ƒ-duplication by setting ƒ=g⁻¹. Two files F₁ and F₂ are hence (ƒ-)duplicates if g_{C}(F₁)=g_{C}(F₂), where g_{C}(F) indicates the second coordinate of g(F), i.e. the (unique) common file of F. However, since the focus of the present system is on transitive duplication, this is the definition that will be used hereinafter.

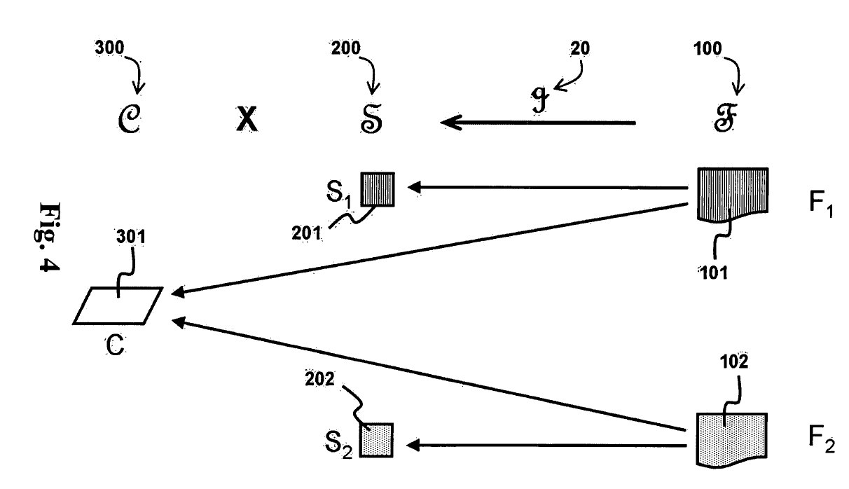

FIG. 4 illustrates this transitive case. A file 101 is processed through function g 20 to produce a specific file 201 and a common file 301. The function g could, for example, simply retrieve the “duplication pertinent” data from file 101 (for example, the contents), which will correspond to common file 301, and the “duplication irrelevant” data of file 101 (for example, the metadata), which will correspond to specific file 201. Yet, function g 20 may be defined in a more complex way to represent other given conceptions of duplication. When the file 102 is processed through function g 20, it produces the specific file 202 and a common file 301, the same common file 301 that file 101 produced. Therefore, under this particular definition, files 101 and 102 are deemed to be duplicates.

### Expressing Common Notions of Duplication

It should be understood that the latter g(F)=(S,C) function can encode many of the notions of duplication that have been presented earlier. But first, it is helpful to review an informal explanation of this function. If one regards two objects to be duplicates, one is projecting on these two objects the idea that they are “identical.” But no two things are exactly identical. For example, two boxes of cereal may seem identical, but if one looks very closely, one will always find some kind of discrepancies at some level. So really, one can only examine a set of aspects of these objects when deciding if they are duplicates (maybe the shape, size, color, brand, taste of contents, etc.). The purpose of the g(F)=(S,C) function is to separate the information that is relevant to the definition of duplication and that which is not.

Preferably, g(F)=(S,C) is set so that C, the common file, corresponds to the relevant information of F, and S to the rest of the (irrelevant) information. With this arrangement or setting, two files are considered duplicates if their relevant information is identical. This is the most widespread understanding of file duplication (or “content duplication”) in the art when one compares a combination of metadata and content information.

In the case of document images, if the idea of duplication is to mean “same text,” then the images can be processed by an Optical Character Recognition (OCR) module to produce files holding the text contents of the images, and duplicate detection can then be performed on these text files. In this situation, the OCR module plays the role of g, where the common file C corresponds to the text file.

The function g corresponds to the computation of the “convergent encryption,” as described in “Reclaiming Space from Duplicate Files in a Serverless Distributed File System,” by John Douceur et al. In this situation, all files are encrypted according to a key that is specific to each user. If the administrating entity has access to these keys, these keys can be used to decrypt the files of the users and perform duplicate detection on the decrypted versions of the files. In this case, the keys (and perhaps some other meta-data) would be considered as the “specific data” and the decrypted versions of the content as “common data.” Douceur, in contrast, describes a method that does not require the keys of the users. Instead, each file is processed in a way so as to produce an alternate file (corresponding to “common file” of the present system) that can be used to check for duplication.

In a scenario in which files have been created or saved under different versions of the same software application, thus exhibiting representational discrepancies, the function g corresponds to saving all files under the same version, so that identical files will be represented identically. In general, g computes the semantics of a file when duplication is viewed as semantic identity.

### Basic Duplicate Detection and Purging Processes

Hereinafter, the task of deciding on duplication is reduced to deciding on byte-wise identity of the files obtained through the function g_{C} (the part of the output of the function g that is in C). If any of the corresponding bytes disagree, the files are not duplicates; otherwise, they are deemed to be duplicates.

In storage management, the goal of locating duplicates is often to purge the file system of needless redundancy. The term “purging duplicates” is used herein to extend the approach consisting of straightforward deletion of duplicates. Indeed, though simply deleting duplicates may be appropriate in some situations, it can be problematic to do so since this would negate the user's ability to retrieve a file from the location in which he had placed it.

Purging duplicates, on the other hand, involves expunging the bulk of the data of a duplicate file, keeping only one copy, but taking the necessary steps so that the file may still be readily accessed; just as if the user owned his own copy. More formally, if F₁, . . . , Fₙ are duplicate files, purging these consists of creating n “specific files” S₁, . . . , Sₙ corresponding to the Fᵢ files, and a “common file” C, such that each original file Fᵢ may be recovered from its specific file Sᵢ and the common file C.

For example, if two files having equal contents are regarded as duplicates, the common file C will correspond to the (common) contents of the files and the specific files will correspond to the (individual) metadata of the files.

Many questions arise as to how to purge duplicates. For example, should a pair (Sᵢ,C) be copied out of its cluster of duplicates as soon as the user makes changes affecting the common file C (“copy-on write” or should this separation happen only when the changes are saved?

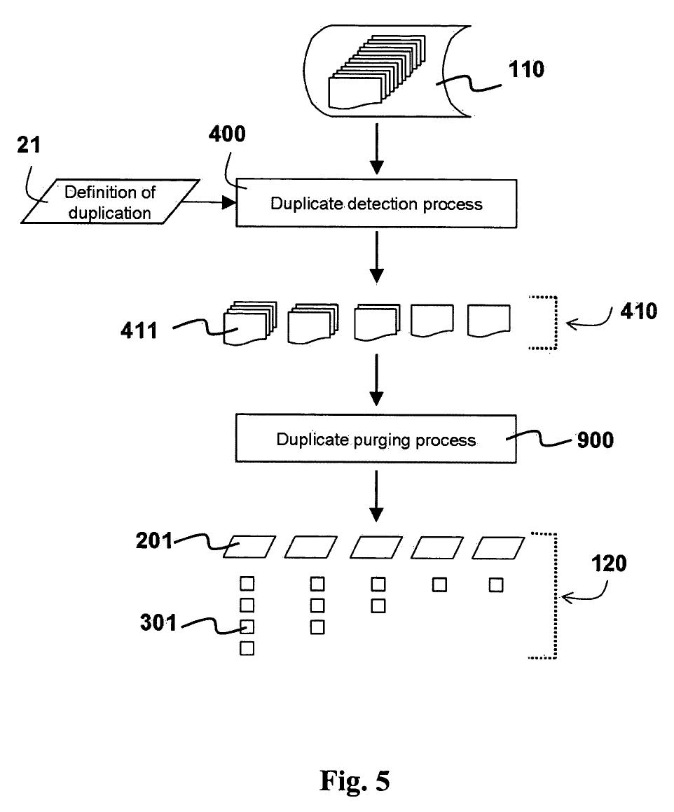

FIG. 5 illustrates a symbolic process flow of duplicate detection and purging of the present invention. A collection of files 110 is first input into the duplicate detection process 400. The particular definition of duplication 21 that the duplicate detection process 400 should use is also provided. It is assumed that the files in the collection of files 110 are of the type imposed or handled by the duplication definition (e.g. if this particular duplication definition relates to MP3 files, all the files of the collection of files 110 should be MP3s).

Once all the collection of files 110 have been fed to the duplicate detection process 400, a group 410 of files 411, or groups of file identification numbers, or in general, any structure specifying the clusters of duplicate files that were found in the file collection 110 are output by the duplicate detection process 400. This information allows one to take whatever action is needed to be taken on duplicates. For example, this information may be fed into the duplicate purging process 900, which purges these groups into a space saving representation 120, by storing the common files 201 only once and keeping the specific files 301 around so as to be able to recover any original file 411 exactly.

Note that the duplicate detection process 400 expresses all files as common and specific files so that it can detect duplication; thus, this information can be passed to the purging process 900. In alternative embodiments, the duplicate detection process 400 and purging process 900 can be integrated into a single, comprehensive process so that no data needs to be passed between the two processes. Also, it should be noted that file collection can, and preferably should, be pipelined into the process flow just described.

### From Files to Pertinent Data, to Duplicate Detection

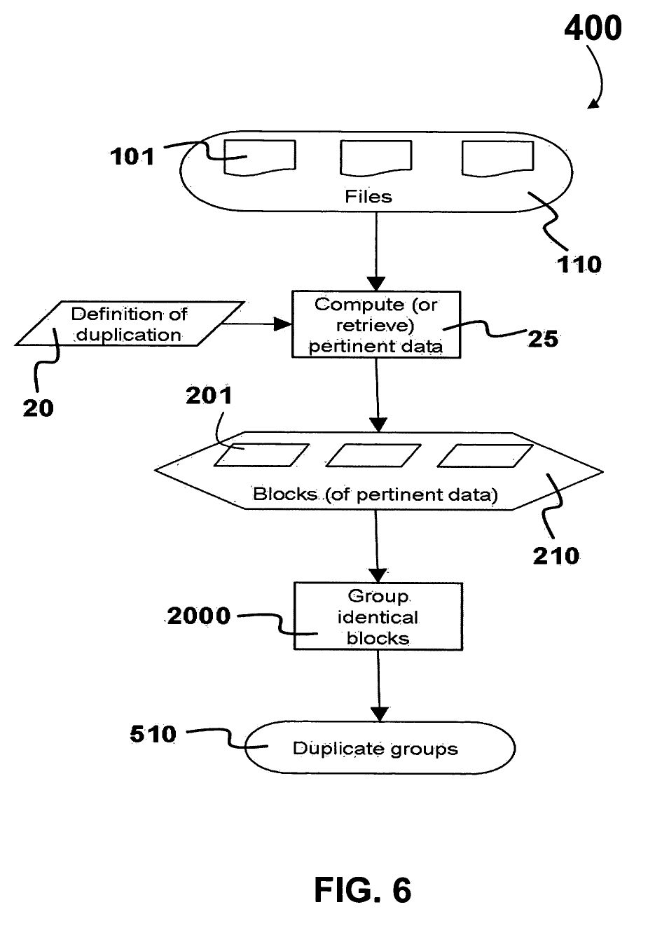

FIG. 6 illustrates a more detailed description of one exemplary duplication detection process 400. A collection 110 of files 101 is input to a process 25, which computes the “pertinent data”, i.e. “the common files” 210 of the files of this collection. For example, the common file 201 of the set of blocks 210 corresponds to the pertinent data of file 101. For simplicity, these common files are called “blocks (of pertinent data),” but this should not be confused with the usual understanding of this term, which often designates an atomic read/write byte sequence of a hard disk. Also, it should be noted that “common files” and “blocks of pertinent data” designate the same data. The process 25 takes a file and computes the “block of data” that will be “pertinent” to the duplication detection process. This same block of data will constitute the “common file” of a group of duplicates—once the purging process is initiated.

How the blocks are computed—or, in the case of simple definitions of duplication, “retrieved”—from a given file is determined by a definition of (transitive) duplication 20, which is also provided or input to process 25. Then the process 2000 assembles the collection of blocks into groups of blocks having identical byte sequences. This means that these groups correspond to groups of duplicate files, hence the output 510.

### Comparing Blocks to Check if they are Identical

Next, the system determines, in a timely manner, if two blocks (byte sequences) are identical. Note, first, that a necessary condition for A and B to be identical is that they be of equal size—this is hereinafter assumed to be true. In fact, since the size of a file is readily accessible, it can be assumed that the size of its image through g_{C} is as well. At least it may be assumed this size may be computed while g_{C} is. For example, in the widespread case where g_{C} simply extracts relevant information from the original file F (e.g. contents and name), the size of F itself may be used for purposes of comparison, since this size relates to that of g_{C}(F) by an additive constant. Note that one can in principle, and in practice, include the size of g_{C}(F) in g_{C}(F) itself.

Several approaches in the at include the byte-wise comparison of files for the purposes of duplicate detection, but it is believed that all of these implicitly refer to a sequential comparison. That is, if the n bytes composing blocks A and B are respectively designated by A₁, . . . , Aₙ and B₁, . . . , Bₙ, in that order, then a byte-wise comparison would refer to the process of comparing A₁ to B₁, then A₂ to B₂, etc. The process being terminated as soon as two disagreeing bytes are found, since A and B are then determined to be non-identical.

Each and every pair of bytes must be compared, and determined to be equal, in order to decide on identity. Yet, as soon as a pair of (corresponding) non-identical bytes is found, this comparison process can terminate—since the blocks are then certainly non-identical. Therefore, it is desirable to find such a pair as soon as possible, if it exists.

In light of this, one may wonder if a sequential comparison of the pair of bytes of two blocks is as good as any other order of comparison, and if not, what would be a better order of comparison.

Sequential comparison has advantages on some level. For example, sequential disk reads are faster than random ones. Yet, this fact must be weighed with the advantage that non-sequential comparisons can offer. Indeed, the internal representation of files conforms to a given syntax particular to the type of the file in question. Sometimes, this syntax may exhibit some level of regularity in the sequence of bytes. For example, many files of a same type will have identical headers; others may have identical “keywords” in precise positions of the file—as is often the case in system files. Whether this regularity is deterministic or statistical, it may be used to accelerate the process of determining whether two (or more) files are identical or not.

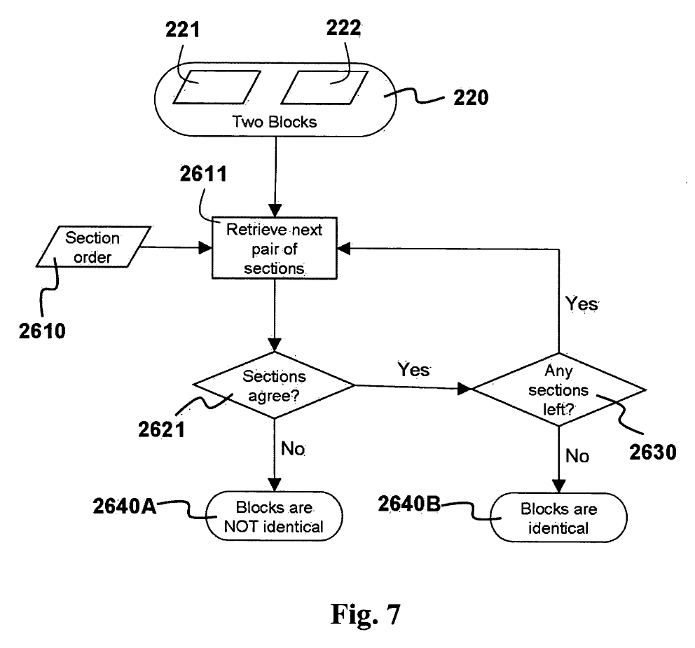

FIG. 7 illustrates a process for comparing two blocks to determine if they are identical. A pair of blocks 220 is provided or input to a process 2611 that retrieves two corresponding sections of these blocks (one from block 221 and one from block 222). The section to be retrieved is determined by the section order 2610, which is also provided to or input to process 2611. The sections are then at step 2621. If the sections are different (i.e. at least one byte is different), the process ends at step 2640A with the decision that the blocks are not identical. If both sections are identical, the system next checks to see if there are any non-compared sections left at step 2630. If there are no sections left to be compared, the process ends at step 2640B with the decision that the blocks are identical. If there are still sections left to be compared, as determined at step 2630, the system retrieves (step 2611) the next pair of sections of the blocks. Again, the inputted section order 2610 determines what the next pair of sections should be.

The section order 2610 can be “learned” (with respect to the type of file, and other properties) automatically by the system, using standard statistical and artificial intelligence techniques. For example, some files may include a standard header format that does not provide any distinguishing information even between non-identical files. In such situations, to speed up the comparison process, it makes no sense to check this section of the file or, alternatively, such section should not be checked until the rest of the file has been checked. Moreover, through some statistical experiments on computer files of several types, it has been discovered (without much surprise) that, in many cases, the bytes (or chunks of bytes) follow sequential patterns (for example, a Markov model). In short, this means that statistically, the bytes of a given section of data are more strongly related to neighboring sections of the data than to sections further away. When this is the case, considering and comparing sections in an order in which each next checked section is as far away as possible from all the previously checked sections will determine if two blocks are non-identical (if they are) faster than the standard or sequential order would (if there is little over head for retrieving these sections in a non-sequential fashion). For example, if two blocks to be compared are divided into nine sections (1, 2, 3, 4, 5, 6, 7, 8, and 9), the comparison order of <1, 9, 5, 3, 7, 2, 4, 6, 8> would perform better than a comparison order of, 1, 2, 3, 4, 5, 6, 7, 8, 9> on average.

The above process just describes the comparison of two files. One could always use such a two-file comparison process on all pairs of a larger collection of files, but when the collection of files to be processed becomes larger, this becomes rapidly inefficient. Handling and comparing a large plurality of files can be done effectively using a methodology known as “divide and conquer.” This methodology is similar to divide and conquer principles used in sorting algorithms and data structure management.

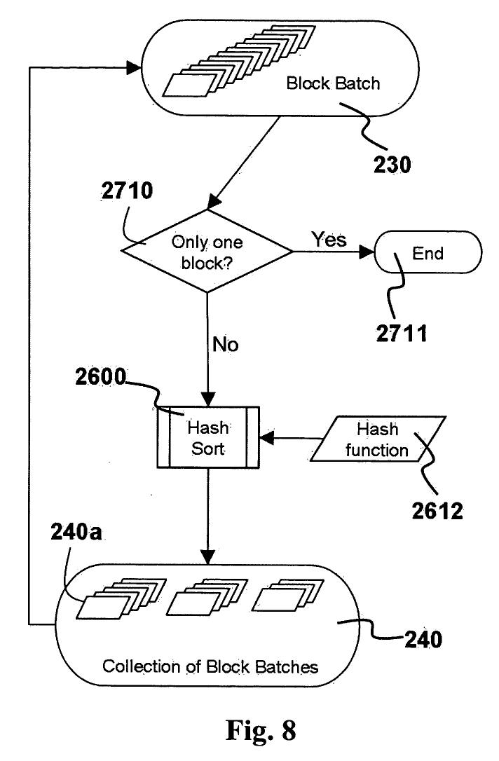

FIG. 8 shows the steps of the hash-sieve process described earlier. This process starts with a collection of blocks 230. If the collection contains only one block (checked for at step 2710), then the process ends (at step 2711). However, if the collection more than one block, the collection is sorted, using hash sort function 2600, which performs a hash on each block, using hash function 2612. This results in the grouping 240 of the blocks of the original collection into buckets of blocks having the same hash value. Each one of these buckets 240a is a collection of blocks that will, in turn, be processed back through the process described in FIG. 8 using another hash. For example, the collection 240a is input in 230 and processed in the manner as just described.

The hash-sieve process of FIG. 8 expresses many existing approaches to duplicate detection. The first hash function could be, for example, the size of the block, and the resulting buckets are, hence, the groups of same-size blocks. The next hash function could be the identity, in which case a byte-to-byte comparison is performed, and the resulting buckets are then the groups of identical blocks, hence, indicating the groups of duplicate files. Before performing a byte-to-byte comparison, many existing schemes choose to perform a few other hash passes—using, for example, CRC or MD5 hash functions.

The reason for performing several hash passes before doing the byte-to-byte comparison is that doing so separates blocks into (hopefully) small buckets of blocks, the blocks of different buckets being non-identical. This allows duplicate detection to be performed on smaller groups of blocks, and even to take out a significant number of blocks from the pool of comparison when they have a unique hash.

There is a tradeoff here. Hashing the blocks allows the system to lower the expected number of comparisons during duplicate detection, but computing the hash of blocks requires a certain amount of computation. In other words, using such hashes as CRC and MD5 may in some cases actually increase the time needed for duplicate detection. In the general hash-sieve approach presented here, the hash function may be automatically selected according to the situation at hand, in order to minimize the expected time needed for duplicate detection. For example, if the number of blocks in the collection is small, one may choose to perform a section-wise comparison as described (for the case of two blocks) in FIG. 7 and for larger collections, some other carefully chosen hash function, as will be appreciated and understood by one skilled in the art.

Note that, in fact, even byte-wise comparison can be expressed as multiple passes through a hash-sieve process. For example, consider the task of carrying out a byte-wise comparison of a batch of blocks. Given the limited bandwidth and processing power of a conventional CPU, it is generally not preferable to compare two blocks in one step, but rather to compare pairs of corresponding sections sequentially. Further, it is more efficient to sort the entire batch according to one section, then sort the smaller (equal section value) batches thus obtained according to another section, etc. As in FIG. 7, the section order is chosen so as to optimize the process by maximizing the chances of section discrepancy, thus minimizing the sizes of the batches. The process just described is a hash-sieve process where a block is hashed to a given section.

### A Few Data-Structures for Block Comparison

A few data structures used in the hash sort process can now be considered. In a naïve approach, a quadratic number of pairs of files (or hashes thereof) would have to be compared to each other to group these files into duplicate (or potentially duplicate) groups. More precisely, if one needed to process n files, the naïve approach would compare n(n−1)/2 files. On the other hand, if these files are, instead, “sorted” according to their hashes, one can process all n files with only nlog₂n, which is a significant improvement when n is large.

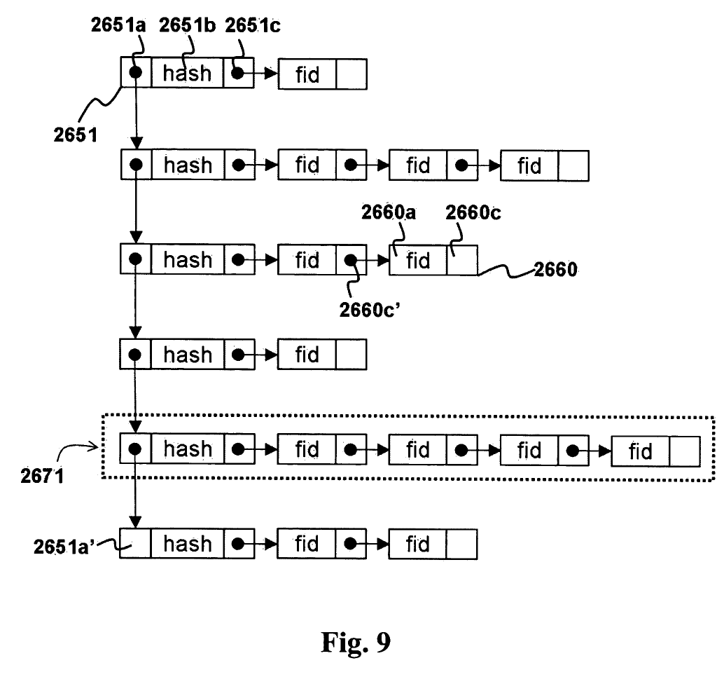

FIG. 9 illustrates a data structure that can be used to perform the hash sort in O(nlog₂n) time (using such known sorting algorithms as merge-sort or quick-sort). This “hash-sort” data structure is a linked list of linked lists. The cells of the lists are of two types: a hash cell (e.g. 2651) and a FID cell (e.g. 2660). A hash cell has a hash value 2651b and a pointer 2651a to the next cell (or a null pointer 2651a′ if the cell is the last of the list). And FID cell has a file identification (fid) field 2660a and a pointer 2660c to the next cell (or a null pointer 2652c′ if the cell is the last of the list). The hash cells (sorted) record the hash values that have been encountered in the considered collection of blocks and the fid cells record the file identification numbers of the files having a particular hash value (e.g. 2671).

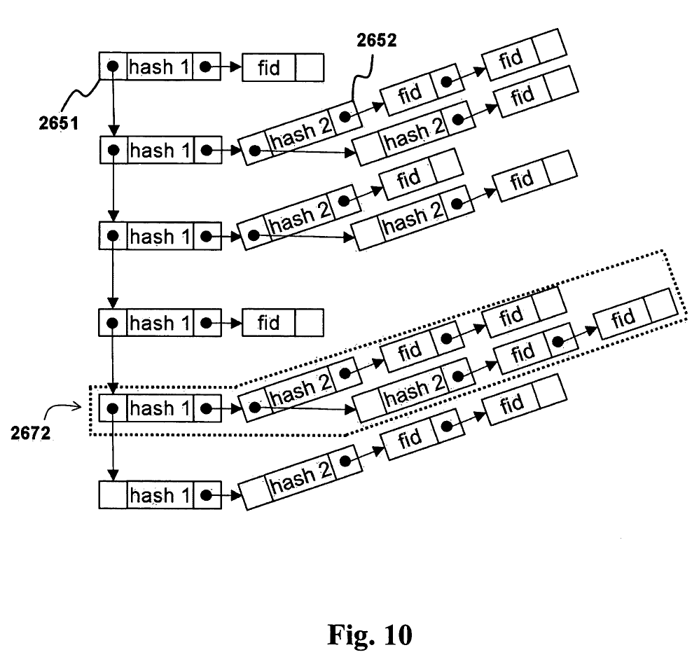

FIG. 10 shows a data structure that keeps track of the different hash values of the blocks during several hash-sieve passes. At each pass, one need only consider the same-hash batches produced by the previous pass and, thus, keeping track of the different hash values of each pass may be unnecessary. On the other hand, keeping record of these different hash values is advantageous if later duplicate detection would need to compute these hash values. This is, for example, the case when one considers duplicate detection over a distributed file system. In such a situation, several duplicated detection agents communicate with each other these hash sort structures so as to share the computational load of a distributed duplication detection process.

The data structure of FIG. 10 is obtained from the data structure described in FIG. 9 by creating a hash-sort data structure for each list of FID cells, using a second hash function. The hash cells (e.g. 2651) of the original data structure are kept, but the list of FID cells it points to with a hash-sort data structure, which uses the new hash function in question, are replaced. In other words, a hash cell (e.g. 2651) will now point to another (new hash function) hash cell (e.g. 2652) indicating the beginning of the new hash-sort data structure. Note that for the immediate purpose of determining block identity, it is unnecessary to compute the new hash of batches having only one block. These may be computed later, if needed for other purposes. The linked-list 2672 corresponds to the linked list 2671 of FIG. 9 that has been processed with the new hash function.

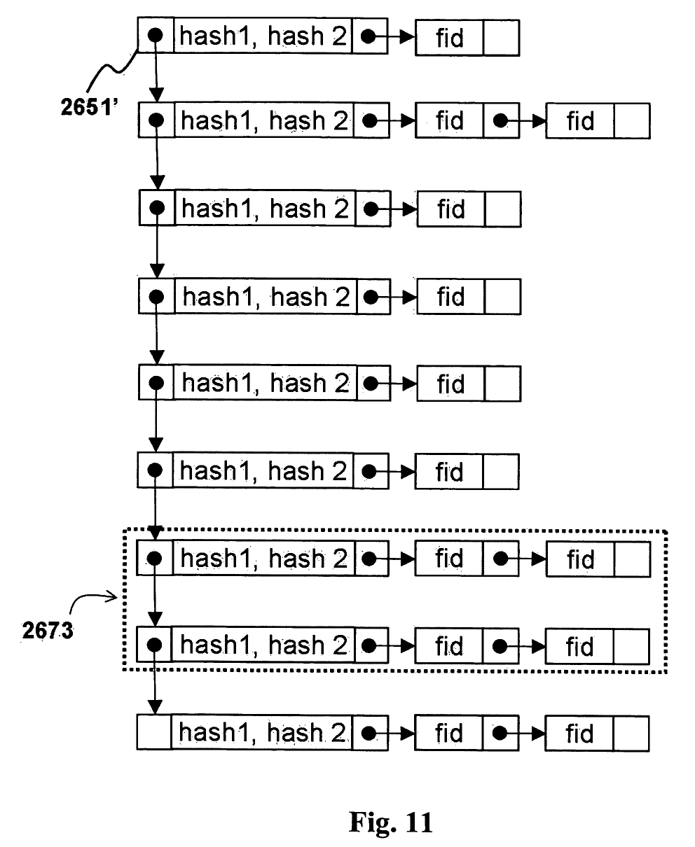

FIG. 11 exhibits an alternate data structure that can be used instead of that described in FIG. 10. In this data structure, instead of breaking up the linked list of FID cells into a hash-sort data structure, the hash cells 2651′ are expanded to contain the new hash values, and the list 2673 is restructured, keeping it sorted first according to the first hash, and second according to the second hash.

### Duplicate Density Map

Next, it is advantageous to have a method for determining where duplicates might be found—so as to guide duplicate detection—from (possibly partial) knowledge of the file operation dynamics of the file server users.

More precisely, it is possible to assign a probability indicating the likelihood that a pair of distinct files are duplicates. Maintaining a separate probability for each pair of files would typically require an impracticable amount of memory and processing. Instead, the present system maintains duplicate densities of sets of pairs—or “cells”)—indicating the percentage of pairs that are pairs of duplicates. This number provides the probability that a randomly chosen pair of the given set of pairs will be a pair of duplicates. Smaller granularity (i.e. bigger cells) does not burden the computing resources as much, but yields less precise estimates, so an appropriate tradeoff must be decided upon. Again, this granularity may be determined by the administrator in the settings of the supplicate management system, or dynamically adapted to the situation at hand, using standard artificial intelligence techniques.

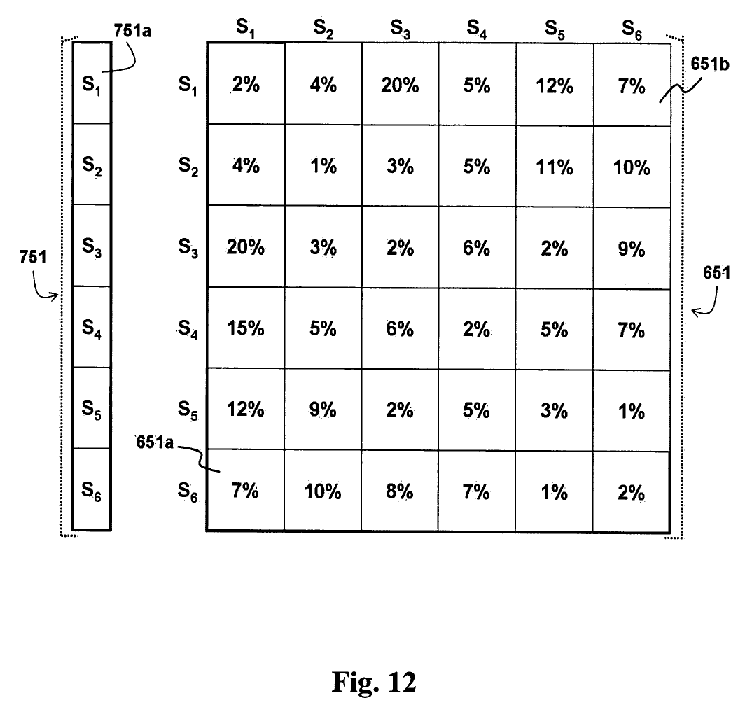

FIG. 12 shows an example of a duplicate density map 651. This map is obtained by partitioning the search space (the subset of the file system is which duplicate detection will be performed) into so called sections and taking the set of (unordered) pairs of sections to be the domain (set of cells) of the map. In this example, the search space 751 is divided into six pieces (called sections) labeled S₁ (751a) through S₆. The domain of the density map corresponds then to the pairs {S₁,S₁}, {S₁,S₂}, . . . , {S₆,S₆}, depicted by the un-shaded squares of the map 651. The cell corresponding to {S₁,S₆} is depicted by cell 651a and by cell 651b, which are, in fact, the same cell. Thus, the shaded cells are not included as describing the domain of the density map 651. The numbers contained in a cell (square) represent the duplicate density forecasted for that cell (i.e. the forecasted percentage of pairs of files of the cell that are duplicates).

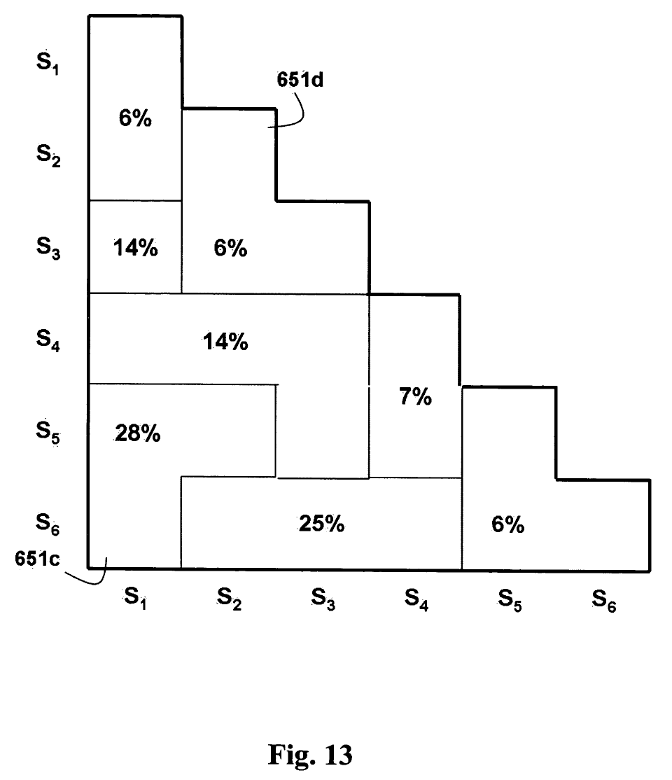

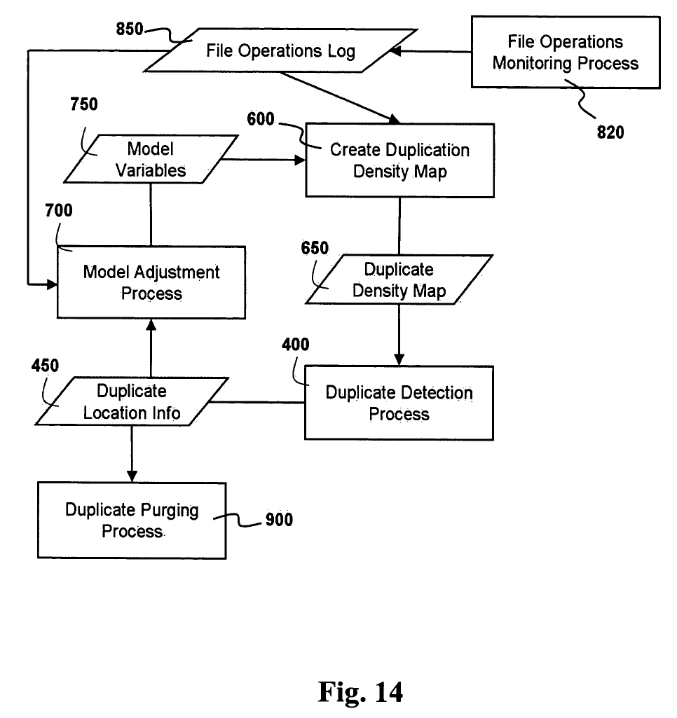

FIG. 13 shows another instance of a duplicate density map, where the cells are not simple pairs of files of two sections—thus producing a grid-like domain. For example, cell 651c contains pairs of {S₁,S₅}, {S₁,S₆}, and {S₂,S₅} and 651d contains files of {S₂,S₂}, {S₂,S₃}, and {S₃,S₃}. In general, the cells could be any sets of pairs of files which partition the search space—not necessarily sets obtained by pairs of sections. It may be useful to allow more complex cell shapes in order to create higher discrepancies of density. Indeed, if all cells have more or less the same density, ordering the duplicate detection will not have much effect. On the other hand, if many cells have high density, and many others have low density, then taking care of the high density ones first will reduce the duplicate detection processing time. This is the case of the duplicate density map depicted in FIG. 13—which was obtained using the densities of FIG. 12—where for example 651c is projected to have 28% of duplicate pairs whereas 651d is projected to only have 6%. The model adjustment process 700, which is described hereinafter with reference to FIG. 14, can eventually adapt the granularity dynamically in order to create these higher density discrepancies.

### Duplicate Density Map Feedback Process

FIG. 14 illustrates one possible implementation of the duplication detection and duplicate density map feedback process. Though this is only one possible implementation, it is fairly general, and instances and variations of this design will be used and described hereinafter in exemplary embodiments of the present invention. The duplicate density map creation process 600 uses a file operations log 850 (provided by a file operations and monitoring process 820) and model variables 750 to create a duplicate density map 650, which is inputted into the duplicate detection process 400. As described previously, the density map 650 is used to guide the duplicate detection process 400—and by thus doing, optimize it. Further, information 450 about the actual number and location of duplicates are then fed into a model adjustment process 700, which uses this information to create new model variables 750 to be fed into the duplicate density map creation process 600 so that the next density map can be more accurate, given that it will take into account the difference between a history of forecasted and actual densities. The model adjustment process 700 also uses the file operations log 850 to better approximate the densities. Additionally, the duplicate location information 450 may be used by another process to perform whatever actions are desired to be performed with the duplicates, such as, for example, use by a duplicate purging process 900, which tells the file system in question how to represent the duplicate files.

The duplicate detection process 400 is able to use the density map 650 in many ways according to the parameters that one wishes to optimize, and what the implementation environment is. One way of optimizing duplicate detection in a large file system, having too many files to process in one batch, is to process batches of files having many duplicates first. By so doing, many duplicates will be found early on, hence maximizing the number of duplicates found if the time allocated to duplicate detection is limited, and further reducing the total time of duplicate detection since many files will be taken out of the search space at an early stage. These batches may be chosen by taking sets of cells of the duplicate density map 650 that have high density first, and batches of cells with lower density later on. In the extreme case, the density map can indicate precisely where the duplicates are.

The process flow described in FIG. 14 expresses a wide range of approaches according to how the different constituent processes are implemented. For instance, the file operations log 850 may be—and remain—empty, meaning that the method described works solely on statistical inference, without any information on the actual dynamics of the file operations. On the other hand, the file operations log 850 may keep track of all file operations, thereby providing the duplicate detection process 400 with exact information of which files are duplicates. In this case, the duplicate density map is, in fact, a “duplicate map” (i.e. an exhaustive list of duplicate pairs) and the duplicate detection process is trivial (thus can be bypassed) since the precision of the duplicate map is in itself the result sought by detection. Also, in this case, the model adjustment process 700 is not needed as the file operations log 850 provides perfect information on the location of duplicates. In short, when the file operations log 850 provides perfect information, it may be in effect communicate directly with the duplicate purging process 900.

When it is not desirable for the file operations log 850 to be made to exhaustively keep track of all low level operations that create and modify the duplicate constitution of the file system, it may be desirable to infer some probabilistic knowledge of the location of duplicates from whatever information is made available. In this case, the file operations log 850 constitutes the observational component of the probabilistic inference, meaning that it carries information of events that affect duplication. This information is enhanced by a statistical component encoded in the model variables 750. These model variables 750 influence the construction of the duplicate density map by the duplicate density map creation process 600 by approximating the information not contained in the file operations log 750.

The first embodiment, which is described herein, presents a few ways to carry out this approach. In this first embodiment, a few simplifying assumptions (that are often valid) are made of the dynamics of duplication. These assumptions basically imply that most duplicates are created by email exchanges and web downloads; therefore, this first embodiment need only keep track of these file operation dynamics. Further, the granularity of the duplicate map of this first embodiment is composed of pairs of user spaces.

There are also many choices for the contents of the model variables 750 and the way the duplicate density map creation process 600 integrates the model variables 750 and the file operations log 850 to create a density map 650. One main aspect of a model is its granularity, which refers to the specification of the cells of the duplicate density map (i.e. the domain of the density function). The granularity of the model can be fixed or variable. In the latter case, a specification of the granularity should be contained in the model variables 750. The second embodiment described herein presents ways to modify the specification of the density map cells dynamically.

In a third embodiment, variable granularity arises when the exact location of duplicates is maintained. In this embodiment, the duplicate density map probabilities will be binary—either 0, indicating a null (or nearly null) probability of a duplicate pair, or 1, indicating absolute (or near absolute) certainty that the pair of files is a duplicate pair. In the case, the duplicate map is in effect a list of file pairs that are (almost) certain to be duplicates.

A fourth embodiment is directed to the situation in which tracking of file operations allows the system to pinpoint duplicates exactly as in the third embodiment (“on-the-fly” duplicate detection) but in which management of the duplicates occurs immediately (“on-the-fly” duplicate purging).

### First Embodiment: Fixed Cells

In order to facilitate the following discussion, many simplifications will be made. It will be understood by those skilled in the art that the scope of the present invention is in no way limited by the following, simplified example.

In this embodiment, the search space of the file server is divided into m sections S₁, . . . , Sₘ; one section per user This means that a cell C_{i,j} will contain all pairs {Fᵢ,Fⱼ} of files such that FᵢεSᵢ is a file of user i and FⱼεSⱼ is a file of user j. One advantage of this choice for granularity is that one does not have to take into account the move operation. Indeed, the move operation, being here a compounded copy and delete inside a same section, does not change any of the densities (the dᵢⱼ).

In this example, it is assumed that most file creations and copies are promptly (before the next duplicate detection) followed by an edit and that the number of duplicates created by downloads from external sites is negligible. Under these assumptions, there will never be any duplicates in a same user's space, or at least these will account for a negligible proportion of the total count. This implies that the duplicates will appear in pairs inside a same cell. Another way to ensure that no duplicates are present in a same user's space is by detecting and purging duplicates in the C_{i,i} cells “on-the-fly” (see fourth embodiment) or before further duplicate detection.

Let t₁, . . . , tₖ, . . . be the times at which duplication detection and purging will be performed. At every given time tₖ, it is desirable to have an idea of the duplicate density dᵢⱼ(tₖ) of every C_{i,j} cell. The setup and assumptions imply that the bulk of the duplicates will have been created by file transmissions (i.e. the downloading of attachments from emails sent between several users of the same file server); thus, it is desirable to estimate at tᵢⱼ(k), the number of files that have been sent by user i to user j during the [tₖ₋₁,tₖ] period.

Often, a file server will keep track of the number of attachments sent from user to user, but not whether a user has actually saved the attachment, nor if a saved attachment is later edited or deleted. In this case, it is desirable to estimate the actual number of transmitted files from the total number of files that have been sent between both users. Let aᵢⱼ(k) be the number of attachments sent from user i to user j during the [tₖ₋₁,tₖ] period. In order to estimate tᵢⱼ(k) the system maintains and updates a set of numbers representing the estimated proportion of received attachments that were actually saved and not edited. Let aᵢⱼ(k) be the estimated proportion of attachments sent from user i to user j that contribute towards the duplicate count during the [tₖ₋₁,tₖ] period. That is, tᵢⱼ(k) is estimated to be aᵢⱼ(k)′aᵢⱼ(k), therefore estimating the density of cell C_{i,j} at time tₖ to be

$${d}_{ij} = \frac{{α}_{ij} ( k ) \times {a}_{ij} ( k ) \times {α}_{ij} ( k ) \times {a}_{ij} ( k )}{\vert {S}_{i} ( k ) \vert \times \vert {S}_{j} ( k ) \vert} ,$$

where |Sᵢ(k)| and |Sⱼ(k)| are respectively the number of files section Sᵢ(k) (files of user i) and section Sⱼ(k) (files of user j) at time tₖ. These can be readily obtained from the file server.

Referring back to FIG. 14, it is evident in the present embodiment, file operations monitoring process 820 only needs to obtain—or keep track of—the number of files in each user's space and how many attachments are sent between each pair of users. At time tₖ, file operations monitoring process 820 communicates aᵢⱼ(k), Sⱼ(k), and Sⱼ(k) to the duplication density map creation process 600 (through log 850), which in turn uses the aᵢⱼ ratios provided by model adjustment process 700 (through model variables 750) to estimate the duplicate density in each cell dᵢⱼ(k) at that point. Note that the aᵢⱼ constitute the only model variables (the granularity is fixed and constant in this embodiment).

When the process flow FIG. 14 is first started (at time t₁), initial values are assigned to the aᵢⱼ. These could be, for example, constant over all pairs of users, or alternatively biased according to some known transmission dynamics. The objective then is to design an algorithm for the model adjustment process 700 that will be able to produce values for aᵢⱼ that will be increasingly close to the actual ratio

$$\frac{{t}_{ij}}{{a}_{ij}} .$$

There are many ways one can infer the values of the aᵢⱼ by incorporating information on the dynamics of the file operations, the previous (actual) duplicate counts, and/or the previous inferred values of the aᵢⱼ.

If duplicate detection has been carried out on all cells at time tₖ, then the actual proportion of attachments that contribute to the duplicate count for each pair of users in the [tₖ₋₁,tₖ] period is known. Let bᵢⱼ(k) be this proportion (for attachments sent by user i to user j).

If it is believed that the aᵢⱼ(k) proportions depend strongly on the most recent dynamics, these may be defined to be equal to the previous actual proportion; namely bᵢⱼ(k−1). On the other hand, if it is believed that these proportions are highly dependent on antecedent proportions, aᵢⱼ(k) may be defined to be the average of all previous actual proportions; namely

$${a}_{ij} ( k ) = \frac{{\sum }_{l = 1}^{l = k - 1} {b}_{ij} ( l )}{k - 1} .$$

These are two extreme choices of a large class of possibilities for forecasting new values of a sequence from the knowledge of previous values. In the same vain, one could choose to set aᵢⱼ(k) to be a weighted average of the previous actual values bᵢⱼ(1), . . . , bᵢⱼ(k−1). There are many other choices for forecasting these proportions, which may be found in the dynamical systems, statistics, or time series literature, for example.

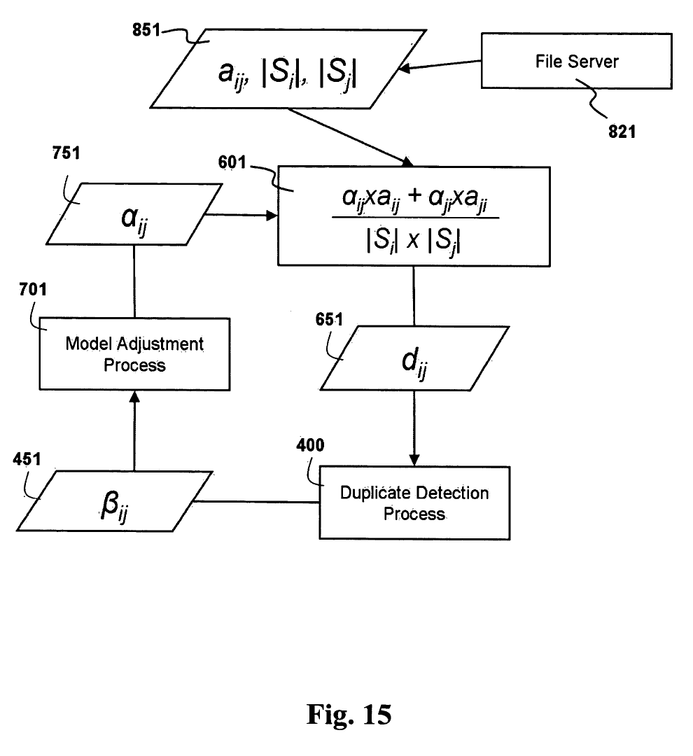

FIG. 15 is similar to FIG. 14 in the context of the present first embodiment. Here, the file server 821 provides the number of attachments sent between every pair of users in any given time frame, along with the total number of files in every section. This information, contained in 851, is fed into 601 which, along with the newest model variables aᵢⱼ(k) (see 751), computes the densities dᵢⱼ (see 651). These densities are fed into the duplicate detection process 400. Once process 400 finds all duplicates in the cells of the duplicate map, it can communicate the number of duplicates bᵢⱼ of these cells (see 451) to the model adjustment process 701, which then compute the aᵢⱼ (see 751) and provides it to process 601 for the next cycle.

### Second Embodiment: Variable Cells

In the first embodiment of the present invention, the granularity was fixed to be composed of all pairs of different users' space. In order to attain more precision, it is possible to divide each user space into several sections, taking the cells of the density map to be all pairs of these sections. Or, if there are many users, it may be advantageous to group users into same sections.

The idea is to define the cells of the density map so that they will exhibit large differences of densities. In the previous scheme, these cells were fixed in advance. This second embodiment shows how the “shape” of these cells can be changed dynamically so as to adapt to present and/or forecasted densities.

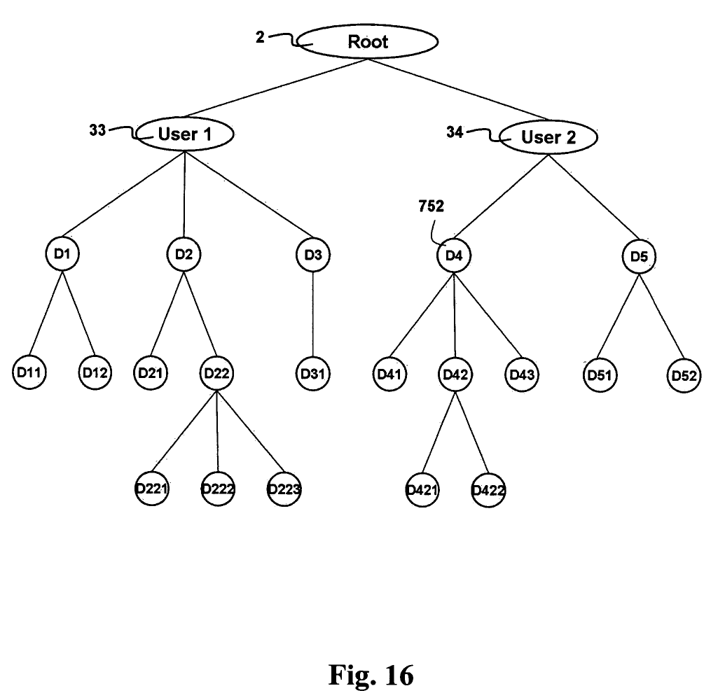

This technique is illustrated using the simple directory structure depicted in FIG. 16. The directory structure is represented by a rooted tree where the root node 2 is the highest level directory, containing one directory per user. These user directories are represented as children nodes of the root node: Node 33 for user 1 and node 34 for user 2. The remaining of the nodes (for example, node 752) represent directories contained by these users, in the standard tree-like fashion.

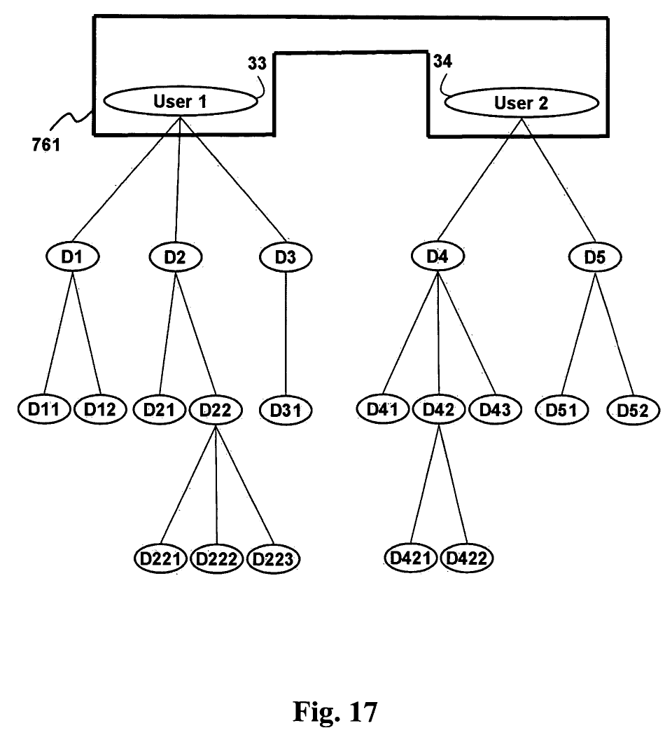

In the previous embodiment of the present invention, the cells of the density map were defined by taking pairs of users. Such a cell is represented in FIG. 17: the polygon 761 of FIG. 17 contains both node 33 and node 34 indicating that this cell is composed of all pairs of files (F₁,F₂) where F₁ is a file of user 1 and F₁ is a file of user 2.

The density attached to this cell may be thought of as the (projected) probability that any given pair of the cell is a duplicate pair. Every pair of the cell is given an equal probability. If there are not too many users, it is possible to divide this cell into smaller parts, allowing the system to have a finer knowledge of where the duplicates might be.

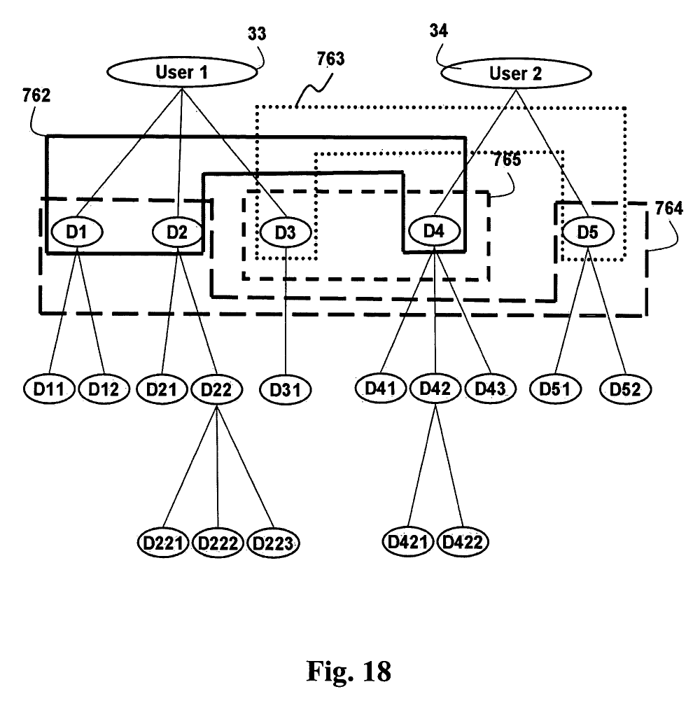

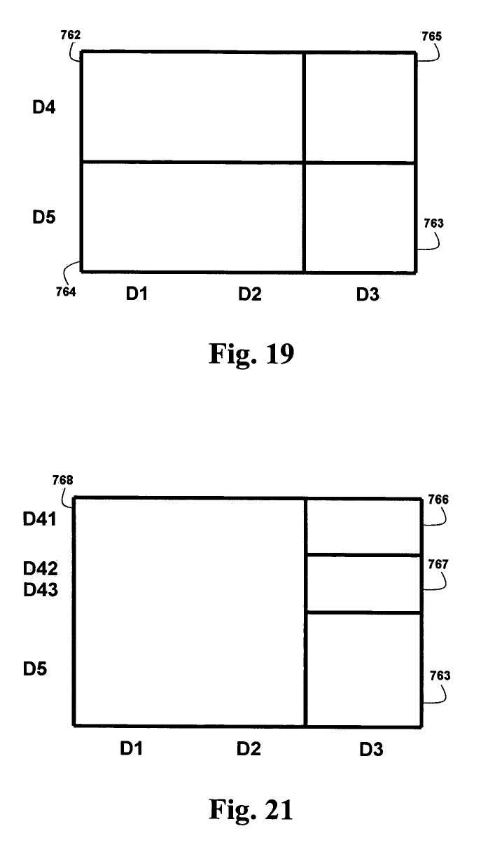

For example, in FIG. 18, instead of one cell, four cells define all possible pairs from the subdirectories of both users. User 1 has three directories (named D1, D2, and D3) in his home directory. User 2 has two directories (named D4 and D5) in his home directory. Cell 763, for example, contains all (D3,D5) pairs: i.e. all pairs of files where one is in D3 (or in subdirectories thereof), and the other in D5 (or in subdirectories thereof). Further, cell 762 contains all (D1,D4) and (D2,D4) pairs, cell 764 contains all (D1,D5) and (D2,D5) pairs, and cell 765 contains all (D3,D4) pairs. These cells are also depicted in FIG. 19, in a manner similar to that of FIG. 12 and FIG. 13.

Suppose the cell 761 of FIG. 17 (or FIG. 19) has a density of, say, 0.1. This means that, according to this density map, all pairs of files between two users have a 10% chance of being duplicates. Yet, with the finer granularity depicted in FIG. 18, we may see that cells 762 and 764 have a density of 0.05 each, cell 763 a density of 0.3, and cell 765 a density of 0.6. This means that in the case depicted in FIG. 18, the duplicate detection can concentrate on cells 763 and 765 first, finding many duplicates early on. With only the info about total density of 761 in FIG. 17, there is no indication of what pairs of this cell (including all pairs described by the cells of FIG. 18) we should try first.

The granularity in FIG. 18 is finer than that in FIG. 17, implying extra duplicate detection efficiency. Finer granularity increases both the computational and memory requirements of the scheme, thus it is necessary to decided in advance how many cells the density map will have. Yet, if the knowledge of duplicate formation allows, one may choose to define these cells so that many of them will have high densities and others low density. In this case, the duplicate detection process will be able to catch many duplicates early on by focusing on high density cells first.

The existence of work groups is one instance where one can infer a probable density structure that can guide the choice of cell definition. Indeed, it is likely that users of a same group will share files and own identical documents in their workspace; at least more so than users of different groups.

Another way to determine a good cell structure is to have the model adjustment process 700 (FIG. 14) adjust the cells of the density map dynamically, adapting to previous duplicate location findings (provided by 450).

Generally, it should be decided in advance how many cells one wants to use in the density map since the greater number of cells, the bigger the load on memory and computing time of the scheme. But once the number of cells has been decided, it must then be determined what pairs they should contain. As mentioned above, the cells may be defined according to some prior conception of where duplicates might be created (according to groups, etc.), yet this biased choice may not actually yield good results if it is, or becomes, unjustified.

One object of the present embodiment is, therefore, to introduce dynamically changing cells which adapt to the fluctuation of the location of duplicates. The general idea is to acquire a scheme that will compel cells to “close in” on areas that have high duplicate density.

Consider the cells, as defined in FIG. 18 and in FIG. 19. Suppose that duplicate detection is performed and the findings indicate that cells 762 and 764 have low density, whereas 765 has high density. If one believes that duplicates tend to be created in same areas—or at least that areas of high density do not tend to shift too fast over time—then it would make sense to force the density map to focus more on areas that were recently dense. This means that it would be advantageous to modify the cells so that previous cells of low density are grouped into fewer cells, and use the savings thus made (since the number of cells to be used in the model is fixed in advance) to break up cells that had high density into smaller pieces.

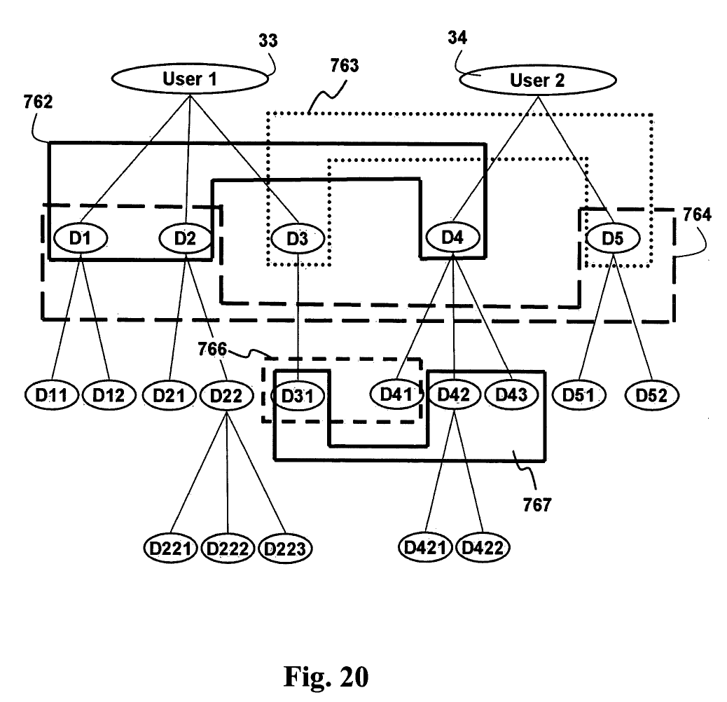

For example, in the present example, it would be advantageous to merge cells 762 and 764 and break up cell 765 into two cells. A cell 766 containing all (D31,D41) pairs and a cell 767 containing all (D31,D42) and (D31,D43) pairs is illustrated in FIG. 20 and FIG. 21.

With reference again to FIG. 14, the model adjustment process 700 is responsible for redefining the cells of the model according to the information provided to it by the duplicate location information 450 and, possibly, the file operations log 850. As in the first embodiment, there are many ways process 700 may use this information to adapt the model. These two possibilities are presented hereinafter. Both of these schemes use solely the duplicate location information provided by duplicate location information 450. It must be indicated that it is possible to modify these schemes in order to integrate a history of duplicate findings and/or the recent file operations provided by file operations log 850 and duplicate location information 450 is assumed to provide a set of groups of locations of duplicate files.

Having the exact location of duplicates and being able to access the total number of files in each directory, the model adjustment process may compute the actual (recent) duplicate densities of the current cells. It could then merge low density cells and break up high density cells, as exemplified in the example just presented.

In an alternative embodiment, the cells are redefined completely, by grouping pairs of directories according to their recent densities in a way that will maximize the density differences between cells.

Techniques helping to adapt cells dynamically (for example, variable-grid and particle filters) can be found in the applied dynamical systems literature.

### Third Embodiment: Binary Density

In the two previous embodiments, the operations monitoring process 820 obtained its information only from records readily available from the file server. This allows for a non-intrusive application. Yet, much more efficient duplicate detection is possible if the operations monitoring process is made aware of all or most of the file operations that take place in the file server.

Such an approach has several advantages. First, this system is able to pinpoint the exact location of most duplicates since it is aware of many of the operations that create these. Pinpointing the exact location of duplicates corresponds to having a precise (albeit perhaps approximate) binary density map, that is, one in which, for each pair of files in the system, a 1 is attached if it is believed that the pair is a pair of duplicates, and 0 if not. Given that most pairs of files of the system are not duplicates, this “density map” should be represented as a list of those pairs that are duplicates, as will be shown later.

A second advantage is that this system, if desired, also manages a purged representation of the files “on-the-fly.” In other words, if a list of duplicates is maintained, idle CPU cycles may be used to purge these duplicates, if purging duplicates is desired.

This third embodiment of the present invention, that is described hereinafter, is not as precise as the “ideal” system just described, but it affords many of its advantages. In this embodiment, the file operations monitoring process only monitors retrieval, store, filename change, copy, and deletion of files. Further, the list of pairs of files (exactly “file locations”) that it maintains are not duplicates with absolute certainty, but with a scalable high probability. This probability can be chosen to be arbitrarily high according to hash functions that are used, at the expense of the necessity for more space and computation time to implement the method. The “suspected” duplicate pairs are then be fed to a duplicate detection process for a final decision or determination.

Advantageously, this third embodiment maintains a hashed representation of all files that are manipulated in a recent past, each hash value being linked to the locations of the files having this hash value. Files having the same hash are likely to be duplicates. These hash values may be computed promptly if this is done while the file is in memory.

With reference again to FIG. 14, processes 700 and 750 may be eliminated from this embodiment since the model parameters will not be adjusted dynamically. Also, the data 850, 650, and 450 communicated between the processes should be placed in memory shared between the relevant processes. This allows this third embodiment to streamline and buffer its tasks, so that the process may be interrupted at any point, and resumed when the CPU load allows.

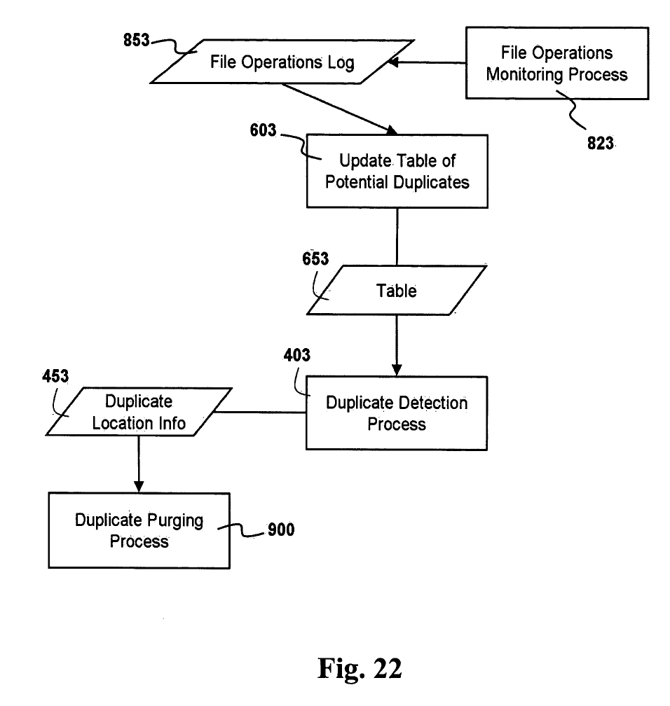

FIG. 22 is similar to FIG. 14 but customized for the third embodiment. Here, the file operations monitoring process 823 is responsible for “catching” all retrieval, store, filename change, copy, and deletion operations. It does so, preferably, by causing a copy of given communications between a user and the file server to be sent to the monitoring process. This can also be done by having the monitoring process regularly check the file server log of operations.

The monitoring process should update a file operations log 853, which is read by the update table process 603, which, in turn, updates a potential duplicates table 653. Once a log entry is read, this entry is deleted from the file operations log 853. If duplicate detection and purging “on-the-fly” is to be performed, when CPU activity allows, the duplication detection process 403 reads off (highly) probable duplicate groups from table 653 and performs a more thorough check (if desired). A list of actual duplicates may be maintained in database 453, which the duplicate purging process 900 accesses in order to identify duplicates for purging. If the table 653 does not have any candidate groups of duplicates, the duplicate detection process 403 continues checking other pairs of files to find duplicates that may have not been caught earlier.

The file operations log 853 should contain all mentioned file operations (retrieval, store, etc.) along with the location of the file in question and a hash value for this file for all but the delete and filename change operation. This location must be an exact, non-ambiguous specification of where the file in question is located (for example, the full path of the file, if none of these may clash in the file system in question). In the case of a copy operation, the relevant file operations log field should specify both the location of the original and the location of the copy. In the case of a filename change, the relevant file operations log field should specify the new name if the location specification depends on the latter.

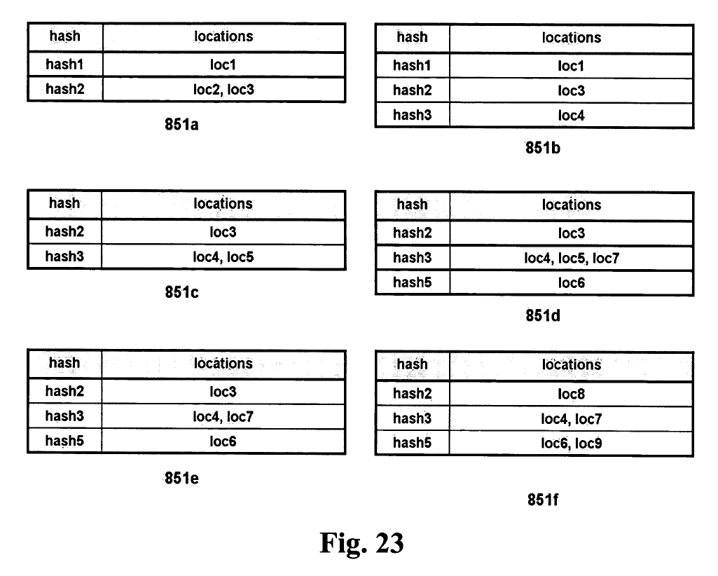

In this third embodiment, the duplicate density map may be thought of as a table 653 having two columns: one for hash values, and another for locations of files having this hash value. Though this density map is represented as a table here, any format or data structure can be used as long as the system is able efficiently to read and update this data structure according to both hash values and file locations. Examples of these tables are given in FIG. 23.

The following illustrates what actions must be taken by the density map creation process 603 on the table 653 depending upon which operations are read from the file operations log 853. These operations are described in a pseudo-language for the file operations log and the actions to be taken on the table.
RETRIEVE(loc, hash) will indicate that a file whose location is “loc” and whose hash value is “hash” was retrieved
STORE(loc, hash) will indicate that a file whose hash value is “hash”, at location “loc” was stored.
DELETE(loc) will indicate that a file located at “loc” was deleted.
COPY(loc1, loc2, hash) will indicate that a file located at “loc1” was copied to location “loc2”.
CHANGE(loc1, loc2) will indicate a filename change. The file is located at “loc1”, and after the filename change, the location (of the same file) was then in location “loc2” (since location includes the file name in its description).

As one skilled in the art will appreciate, the COPY operation may be eliminated if such operation will be “caught” by the file server as a RETRIEVE(loc1, hash) followed by a STORE(loc2, hash). Similarly, a MOVE operation can be represented by a COPY followed by a DELETE. In general, the above list of operations is merely representative. Not all of these operations need to be included and, if desired, additional operations can be included. The exact operations chosen by the system operator merely affect the precision of the resulting table of potential duplicates.

Now, the two actions that will be taken on the table are described. For example, if the table starts out empty (which it will), then none of these actions will lead to more than one row indexed by the same hash value, nor will they lead to having a same location specification in several rows (i.e. with different hash values).
INSERT(hash,loc) indicates the insertion of the pair “(hash,loc)” into the table. More precisely, if the table has a row indexed by “hash”, then “loc” will be added to the list of locations there (if it is not already there). If the table has neither a row indexed by “hash”, nor a location “loc” anywhere, a new row should be created, indexed by “hash” and containing “loc” as a (singular) list of locations.
REMOVE(loc) indicates the removal of the pair “loc” from the table. More precisely, “loc” is removed from the corresponding from the (unique) list it is contained in, if there is such a list. If “loc” was the only location of this list, the whole row is removed from the table.
REPLACE(loc1,loc2) replaces “loc1” with “loc2” in the list where “loc1” is contained, if there is such a list.

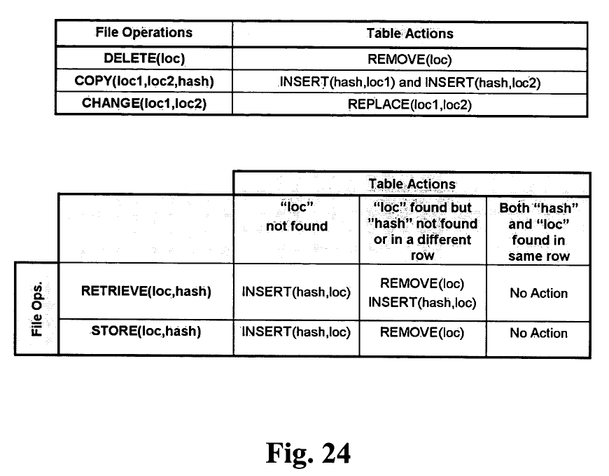

FIG. 24 illustrates the different file operations that will appear in the file operations log 853 (FIG. 22) with the corresponding actions that should be taken on the table 653. A feature of this third embodiment is the grouping of all manipulated files according to their hash value so as to keep record of the locations of files that are highly likely to be duplicates. With this in mind, the following paragraphs explain the rationale for the various table actions shown in FIG. 24:
If a file is deleted, it is no longer a duplicate of any other file, so must be removed from the “potential duplicates” list. Further, if no other file had a same hash value, the row that contained the hash and location of the deleted file is preferably removed to save space.
If a file is copied, a pair of duplicates is created, and will appear in a same row of the table. If other recently-manipulated files have the same hash value as these copies, the whole group is a potentially a group of duplicates.
If a filename changes and its location appears in the table, this location must be changed to reflect the filename change. This should be done in general with any operation that effects the location of files.
If a file F is retrieved, it may be later edited, or sent by email, etc. Thus, the table must keep record of it so that later retrieved or stored duplicates of F may be matched with it. This is done with the RETRIEVE(hash,loc) operation. If “loc” is not found in the table, it is inserted into a pre-existing row indexed by “hash”—which means that some file(s) that are potentially duplicates of F (since they had the same hash value as F) were earlier retrieved or stored. If no row is indexed by “hash”, a new row is created to accommodate the pair (hash,loc). If “loc” is found but “hash” is not, that means that the file at location “loc” was changed and this change was not caught by the file operations monitor. Preferably, the system keeps a record of the file just retrieved instead of the earlier file. This is done by removing “loc” from the row where it was, and creating a new row to accommodate the “loc” with the new hash value of the file to which it points. If “hash” and “loc” are found in the same row, there is nothing to do.
If a file F is stored, it may be that a new file was created, or F was downloaded from an email attachment or from the Internet, or it may have been earlier retrieved, edited, and now stored. If “loc” is not found, it probably was not retrieved earlier since the table would indeed contain “loc.” Thus, the system keeps a record of it so as to group it with earlier duplicate files downloaded by other users and/or to make sure that later duplicate files that will be stored will be able to be grouped with it. If “loc” is found but the corresponding “hash” is not (or if “hash” appears in a different row), it is likely that that a file was earlier retrieved from this location, then edited (thus changing its hash value), and now stored. In this situation, the system simply removes “loc” from the row in which it appears (removing the entire row if “loc” was the single location in the list). If “hash” and “loc” are found in the same row, there is nothing to do.

FIG. 23 illustrates how a density map table is updated, given an exemplary sequence of file operations. In this example, the table starts out empty and the file operations log 853 shows the following operations:
op.1 RETRIEVE(loc1, hash1)
op.2 COPY(loc2, loc3, hash2)
op.3 DELETE(loc2)
op.4 RETRIEVE(loc4, hash3)
op.5 STORE(loc1, hash4)
op.6 STORE(loc5, hash3)
op.7 STORE(loc6, hash5)
op.8 STORE(loc7, hash3)
op.9 RETRIEVE(loc5, hash3)
op.10 STORE(loc5, hash6)
op.11 CHANGE(loc3, loc8)
op.12 STORE(loc9, hash5)
   Table 851a of FIG. 23 illustrates the density map table after op.1 and op.2 are integrated. Table 851b then shows the effect of op.3 and op.4; table 851c after op.5 and op.6 are integrated, table 851d after op.7 and op.8 are integrated, table 851e after op.9 and op.10 are integrated, and, finally table 840f after op.11 and op.12 are integrated.

As will be appreciated, since records may be inserted in the table 851 and never have a chance to be removed, it is advantageous for there to be a method for automatic removal of these records. For example, a file may be retrieved, but unless it is edited and then stored, the above system has no way of removing this record.

One solution for addressing this situation is to run a clean up process based on the amount of time these records are present in the table. For example, when inserting a new record, a time stamp can be attached to the location that is being stored. The process 653, which updates the table of potential duplicates, is programmed to get rid of records that have been in the table too long (this being specified by a max-time parameter). Further, there are scenarios in which certain records may need to kept longer than others. For example, if a file is simply retrieved, it should probably remain a shorter amount of time than if it were later sent to other users as an attachment or if this file was stored from a web download. In this is desired, file type properties can be maintained and associated with the recorded locations, so that such properties can be used to determine when files can be removed from the table.

### Fourth Embodiment: Totally “On-The-Fly”

In the third embodiment, and with reference to FIG. 14, file operations records were buffered in the file operations log 850, read by process 600, which would update a table indicating where likely duplicates might be. Once determined to actually be duplicates by process 400, the duplicate purging process 900 took care of purging these duplicates.

One may make the communication between components 820, 600, 400, and 900 direct, thus, performing “on-the-fly” duplicate purging process. If, instead of being passed directly to the file server for immediate action, the file operations were passed through the on-the-fly purging process, one could constantly maintain a purged representation of the files of the system. Such an approach would only be feasible if the purging process were fast enough not to create any lag of response during the users' actions.

Here, some operations may be directly communicated to the purging process, thus avoiding any lag. This method makes advantageous use of a special file system—or an application layer on top of the files system—in the server. Hereinafter, this layer is referred to as duplicate detection middleware—or simply “middleware.” Certain file operations performed by users are passed to the middleware. The middleware is responsible for recognizing duplicates and managing a purged representation of the files (storing only one common file of each file together with the specific files). In this sense, the middleware acts both as a “file operations monitoring process” and a “duplicate purging/managing process.”

There are several file operations which can be handled by the middleware efficiently without running the duplicate detection process; namely: COPY, MOVE, and DELETE. If a file is copied, only the specific file has to be copied because the common file remains the same. If a file is moved, only a move of a specific file is required. The delete operation only deletes the corresponding specific file. In the case of the edit and transmission operations, it is more difficult to manage directly the appearance and disappearance of duplicates: Here some “after-the-fact” duplicate detection may be opportune. Yet since the middleware is aware of all file operations, it can determine the location of duplicates with much more precision than the earlier approaches afforded.

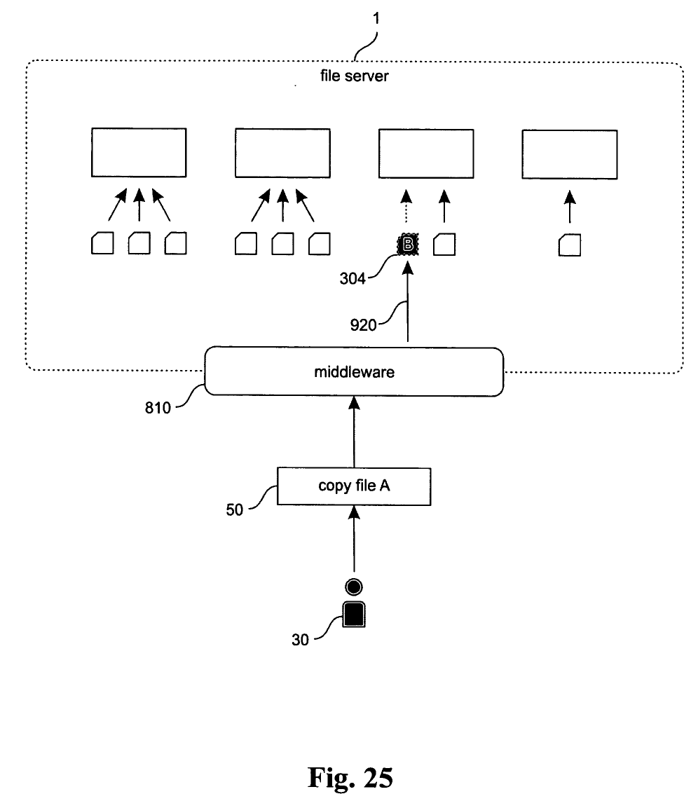

The copy operation is outlined in FIG. 25. The file server 1 contains all unique common files 202 and also their corresponding specific files 302 in a special file system. The duplicate detection functionality is provided via the middleware 810 and all file operations are passed through the middleware 810. The special file system may be also any standard file system, but the middleware 810 is responsible for associating the files to their common 202 and specific 302. The user 30 sends a request 40 to the middleware 810 for a copy of file A. The request is transparent to the user in the sense that he uses standard file management tools and the requests are translated and sent on a lower level. The request is in the next step handled by the 810 and translated to an inner action 910 and a new instance of a specific file 303 is ultimately created and pointed to the same common file.

Note that this “purged” way of copying prevents a user from creating actual duplicates in his allocated space by a copy operation; hence, the only way he can create duplicates is by downloading several times a same file.

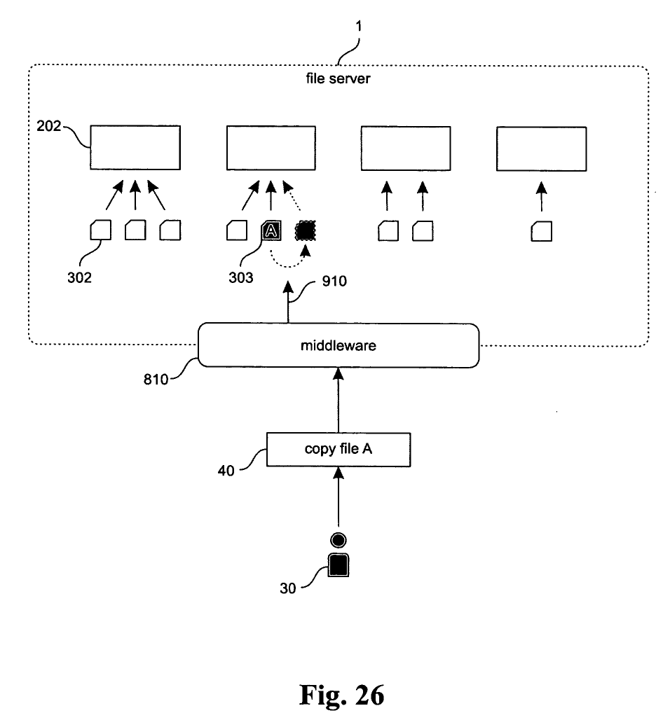

The delete operation is outlined in FIG. 26. The user 30 again initiates the delete request 920. The request is translated via the middleware to an internal sequence of commands 304 and the corresponding specific file is deleted. The move operation, being in effect a copy followed by a delete, is hence managed by the middleware as well.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. A method of managing duplicate electronic files for a plurality of users across a distributed network, the electronic files being from a plurality of different file types, comprising the steps of:
(i) selecting a file type from the plurality of different file types;
(ii) selecting properties of the electronic files for the selected file type that must be identical in order for two respective electronic files of the selected file type to be considered duplicates, the selected properties defining pertinent data of the electronic files for the selected file type;
(iii) grouping electronic files of the selected file type stored in the distributed network;
(iv) ranking said groupings from highest to lowest based on a likelihood of having duplicate electronic files therein;
(v) systematically comparing pertinent data of electronic files from said highest to said lowest ranked groupings; and
(vi) identifying duplicates from said ranked groupings based on said systematic comparisons.

2. The method of claim 1 wherein the file type is indicative of the application used to create, edit, view, or execute the electronic files of said file type.

3. The method of claim 1 wherein the selected properties are common to more than one of the plurality of different file types.

4. The method of claim 1 wherein properties of the electronic files include file metadata and file contents.

5. The method of claim 4 wherein file metadata and file contents include file name, file size, file location, file type, file date, file application version, file encryption, file encoding, and file compression.

6. The method of claim 1 wherein grouping electronic files is based on file operation information.

7. The method of claim 1 wherein grouping electronic files is based on users associated with the electronic files.

8. The method of claim 1 wherein ranking said groupings is made using duplication density mapping that identifies a probability of duplicates being found within each respective grouping.

9. The method of claim 8 wherein the probability is based on information about the users associated with the electronic files of each respective grouping.

10. The method of claim 8 wherein the probability is modified based on previous detection of duplicates within said groupings.

11. The method of claim 8 wherein the probability is modified based on file operation information.

12. The method of claim 11 wherein the file operation information is provided by a file server on the distributed network.

13. The method of claim 11 wherein the file operation information is obtained from monitoring user file operations.

14. The method of claim 11 wherein the file operation information is obtained from a file operating log.

15. The method of claim 11 wherein the file operation information includes information regarding email downloads, Internet downloads, and file operations from software applications associated with the electronic files.

16. The method of claim 1 wherein systematically comparing is conducted by recursive hash sieving the pertinent data of the electronic files.

17. The method of claim 16 wherein recursive hash sieving progressively analyzes selected portions of the pertinent data of the electronic files.

18. The method of claim 1 wherein systematically comparing is conducted by comparing electronic files on a byte by byte basis.

19. The method of claim 1 wherein systematically comparing further comprises the step of computing the pertinent data of the electronic files.

20. The method of claim 1 wherein systematically comparing further comprises the step of retrieving the pertinent data of the electronic files.

21. The method of claim 1 wherein systematically comparing further comprises comparing sequential blocks of pertinent data from the electronic files.

22. The method of claim 1 wherein systematically comparing further comprises comparing nonsequential blocks of pertinent data from the electronic files.

23. The method of claim 1 wherein systematically comparing is performed on a batch basis.

24. The method of claim 1 wherein systematically comparing is performed in real time in response to a selective file operation performed on a respective electronic file.

25. The method of claim 1 further comprising the step of generating a report regarding said identified duplicates.

26. The method of claim 1 further comprising the step of deleting said identified duplicates from the network.

27. The method of claim 1 further comprising the step of purging duplicative data from said identified duplicates on the network.

28. The method of claim 1 further comprising the step of identifying one common file for each of said identified duplicates and identifying a respective specific file for each electronic file of said identified duplicates.

29. The method of claim 28 wherein the common file includes the pertinent data of said identified duplicates.

30. The method of claim 1 further comprising the step of modifying at least one electronic file to obtain its pertinent data.

31. The method of claim 30 wherein said step of modifying comprises converting said electronic file into a different file format.

32. The method of claim 30 wherein said step of modifying comprises converting said electronic file into a different application version.

33. A method of managing duplicate electronic files for a plurality of users across a distributed network, the electronic files being of a particular file type, comprising the steps of:
(i) selecting properties of the electronic files that must be identical in order for two respective electronic files to be considered duplicates, the selected properties defining pertinent data of the electronic files;
(ii) grouping electronic files stored in the distributed network based on file operation information or based on users associated with the electronic files;
(iii) ranking said groupings from highest to lowest based on a likelihood of having duplicate electronic files therein;
(iv) systematically comparing pertinent data of electronic files from said highest to said lowest ranked groupings;
(v) identifying duplicates from said ranked groupings based on said systematic comparisons; and
(vi) purging identified duplicates from the network.

34. The method of claim 33 wherein the step of purging comprises identifying one common file for each of said identified duplicates and identifying a respective specific file for each electronic file of said identified duplicates.
